(19) United States
(12) Patent Application Publication
(10) Pub. No.: US 2024/0390785 A1
(43) Pub. Date: Nov. 28, 2024

(54) INFORMATION PROCESSING APPARATUS, INFORMATION PROCESSING METHOD, AND PROGRAM

(71) Applicant: SONY GROUP CORPORATION, Tokyo (JP)

(72) Inventors: Ikuo YAMANO, Tokyo (JP); Yusuke Nakagawa, Kanagawa (JP); Ayumi Nakagawa, Kanagawa (JP)

(73) Assignee: SONY GROUP CORPORATION, Tokyo (JP)

(21) Appl. No.: 18/797,547

(22) Filed: Aug. 8, 2024

Related U.S. Application Data
(63) Continuation of application No. 17/422,832, filed on Jul. 14, 2021, now abandoned.

(30) Foreign Application Priority Data
Jan. 21, 2019 (JP) 2019-007579

(51) Int. Cl. A63F 13/285; A63F 13/211; A63F 13/24

(52) U.S. Cl. CPC A63F 13/285; A63F 13/211; A63F 13/24; A63F 2300/1037

(57) ABSTRACT

An information processing apparatus according to an embodiment of the present technology includes: a haptic control unit. The haptic control unit controls, on the basis of a haptic presentation signal according to haptic content to be presented to a haptic presentation apparatus and contact body information relating to a contact body that is in contact with the haptic presentation apparatus, a haptic output signal to be output to the haptic presentation apparatus.

### CROSS REFERENCE TO PRIOR APPLICATION

This application is a continuation of U.S. Patent Application No. 17/422,832 (filed on Jul. 14, 2021), which is a National Stage Patent Application of PCT International Patent Application No. PCT/JP2020/000177 (filed on Jan. 7, 2020) under 35 U.S.C. § 371, which claims priority to Japanese Patent Application No. 2019-007579 (filed on Jan. 21, 2019), which are all hereby incorporated by reference in their entirety.

### TECHNICAL FIELD

The present technology relates to an information processing apparatus, an information processing method, and a program that are applicable to haptic presentation.

### BACKGROUND ART

In recent years, a technology for presenting various haptic perceptions to a user has been developed. For example, a haptic perception corresponding to a vibration pattern is presented to the user by vibrating an apparatus with a predetermined vibration pattern.

Patent Literature 1 describes a haptic device configured to be wearable on the body of a user. A moveable body configured to be capable of vibrating in a plane by an X actuator and a Y actuator is provided to the haptic device. The movable body is vibrated on the basis of a vibration waveform using, for example, a detection threshold value of a human haptic receptor. This vibration waveform is set to include amplitude and frequency ranges that are detectable or undetectable by a person. As a result, it is possible to present a variety of haptic perceptions such as frictional force to a user (paragraphs [0019], [0021], and to and FIGS. 1 and 3 of Patent Literature 1, etc.).

### CITATION LIST

### Patent Literature

Patent Literature 1: WO 2016/031118

### DISCLOSURE OF INVENTION

### Technical Problem

In the future, the technology for presenting a haptic perception to a user is expected to be applied to various apparatuses such as amusement machines, portable apparatuses, and wearable apparatuses, and a technology capable of presenting a desired haptic perception is desired.

In view of the circumstances as described above, it is an object of the present technology to provide an information processing apparatus, an information processing method, and a program that are capable of presenting a desired haptic perception.

### Solution to Problem

In order to achieve the above-mentioned object, an information processing apparatus according to an embodiment of the present technology includes: a haptic control unit.

The haptic control unit controls, on the basis of a haptic presentation signal according to haptic content to be presented to a haptic presentation apparatus and contact body information relating to a contact body that is in contact with the haptic presentation apparatus, a haptic output signal to be output to the haptic presentation apparatus.

In this information processing apparatus, a haptic output signal that is an output to the haptic presentation apparatus is controlled. The control of the haptic output signal is executed on the basis of the haptic presentation signal according to the haptic content for the haptic presentation apparatus and the contact body information relating to the contact body that is in contact with the haptic presentation apparatus. As a result, it is possible to control the haptic output signal in accordance with the contact body, and present a desired haptic perception.

The haptic control unit may control the haptic output signal on the basis of correction information and the haptic presentation signal, the correction information being used for correcting the haptic presentation signal on the basis of the contact body information.

This makes it possible to correct the operation of haptic presentation apparatus in accordance with the contact body. As a result, it is possible to present a desired haptic perception with high accuracy.

The haptic presentation signal may be a signal that represents an amplitude and a frequency component of a vibrating device for exciting the haptic presentation apparatus. In this case, the haptic control unit may generate, on the basis of the contact body information, the correction information regarding at least one of the amplitude and the frequency component represented by the haptic presentation signal.

This makes it possible to correct the haptic presentation signal in detail. As a result, it is possible to present a desired haptic perception with high accuracy The contact body may include an attachment to be mounted on the haptic presentation apparatus. In this case, the haptic control unit may acquire, as the contact body information, mass information regarding mass of the attachment.

As a result, even in the case where the attachment is mounted, it is possible to appropriately vibrate the haptic presentation apparatus and exhibit excellent haptic effects. The haptic control unit may calculate, on the basis of the mass information, a rate of change in acceleration along with mounting of the attachment, the acceleration being generated in the haptic presentation apparatus due to vibration of the vibrating device.

Thus, the ratio of the change in the acceleration before and after mounting the attachment is calculated. As a result, it is possible to appropriately correct the change in the haptic perception, or the like along with the mounting of the attachment.

The haptic control unit may correct the amplitude of the haptic presentation signal on the basis of the rate of change in the acceleration.

As a result, it is possible to correct the intensity of the vibration with high accuracy, and present haptic content at desired strength.

The haptic control unit may calculate, on the basis of the mass information, a shift amount of a resonant frequency of a vibration system including the vibrating device along with mounting of the attachment.

Thus, the amount of change in the resonant frequency before and after the mounting of the attachment is calculated. As a result, it is possible to appropriately correct the change in the haptic perception along with the mounting of the attachment.

The haptic control unit may correct, on the basis of the shift amount of the resonant frequency, the frequency component of the haptic presentation signal.

This makes it possible to perform haptic presentation using the resonant frequency after the mounting of the attachment, for example. As a result, it is possible to present haptic content at sufficient strength.

The attachment may be capable of supplying device information of the attachment. In this case, the haptic control unit may acquire the mass information on the basis of the device information of the attachment.

As a result, it is possible to acquire the mass of the attachment easily with high accuracy, and easily present a desired haptic perception even in the case where the attachment is mounted.

The haptic control unit may acquire the mass information on the basis of input information input by a user.

As a result, it is possible to correct the haptic presentation signal regardless of the type of the attachment or the like.

The haptic presentation apparatus may include an acceleration sensor for detecting acceleration of the haptic presentation apparatus. In this case, the haptic control unit may calculate the mass information on the basis of a detection result of the acceleration sensor.

As a result, for example, it is possible to calculate the mass or the like of an arbitrary attachment, and appropriately correct the haptic presentation signal.

The acceleration sensor may detect first acceleration generated, in accordance with a predetermined vibration signal, in the haptic presentation apparatus on which the attachment has been mounted. In this case, the haptic control unit may acquire second acceleration generated, in accordance with the predetermined vibration signal, in the haptic presentation apparatus on which the attachment has not been mounted, and calculate the mass information on the basis of the first acceleration and the second acceleration.

This makes it possible to calculate the mass or the like of an arbitrary attachment with high accuracy. As a result, it is possible to present a desired haptic perception with high accuracy.

The haptic control unit may calculate the mass information on the basis of a temporal change in the acceleration detected by the acceleration sensor.

As a result, for example, in the case where the use status of the haptic presentation apparatus changes, it is possible to appropriately calculate the mass or the like of the attachment.

The vibrating device may be supported by a casing of the haptic presentation apparatus. In this case, the haptic control unit may correct the haptic presentation signal on the basis of an interference condition regarding a mechanical interference between the vibrating device and the casing.

This avoid situations where the vibrating device interferes with the casing. As a result, it is possible to suppress abnormal sounds and the like and appropriately present a desired haptic perception.

The vibrating device may be a linear vibrating actuator.

As a result, it is possible to easily present a variety of haptic perceptions.

The linear vibrating actuator may be a voice coil motor.

As a result, it is possible to easily present a variety of haptic perceptions at sufficient strength.

The contact body may include a hand of a user gripping the haptic presentation apparatus. In this case, the haptic control unit may acquire, as the contact body information, gripping-force information regarding a gripping force of the user gripping the haptic presentation apparatus.

As a result, even in the case where the force of the like by which the user grips the haptic presentation apparatus changes, it is possible to appropriately vibrate the haptic presentation apparatus and exhibit excellent haptic effects.

The haptic presentation apparatus may include an acceleration sensor for detecting acceleration of the haptic presentation apparatus. In this case, the haptic control unit may calculate the gripping-force information on the basis of a detection result of the acceleration sensor.

This makes it possible to easily detect the change or the like of the gripping force of the user. As a result, it is possible to appropriately correct the change in the haptic perception, or the like due to the change in the gripping force.

An information processing method according to an embodiment of the present technology is an information processing method executed by a computer system, including: controlling, on the basis of a haptic presentation signal according to haptic content to be presented to a haptic presentation apparatus and contact body information relating to a contact body that is in contact with the haptic presentation apparatus, a haptic output signal to be output to the haptic presentation apparatus.

A program according to an embodiment of the present technology causes a computer system to execute the following step of:
controlling, on the basis of a haptic presentation signal according to haptic content to be presented to a haptic presentation apparatus and contact body information relating to a contact body that is in contact with the haptic presentation apparatus, a haptic output signal to be output to the haptic presentation apparatus.

### Advantageous Effects of Invention

As described above, in accordance with the present technology, it is possible to present a desired haptic perception. Note that the effect described here is not necessarily limitative, and any of the effects described in the present disclosure may be provided.

### BRIEF DESCRIPTION OF DRAWINGS

FIG. 1 is a schematic diagram showing an outline of a haptic presentation system according to a first embodiment of the present technology.

FIG. 2 is a block diagram showing a configuration example of the haptic presentation system shown in FIG. 1.

FIG. 3 is a schematic diagram showing an example of a game controller.

FIG. 4 is a schematic diagram showing a configuration example of a voice coil motor.

FIG. 5 is a schematic diagram showing an example of an attachment.

FIG. 6 is a schematic diagram showing a vibration model of a vibration system to which a voice coil motor is connected.

FIG. 7 is a graph showing an example of vibration characteristics of the vibration system to which the voice coil motor is connected.

FIG. 8 is a graph showing an example of a relationship between the mass of a vibration target and the resonant frequency of the vibration system.

FIG. 9 is a graph showing a relationship between the generated acceleration and input-voltage before and after mounting the attachment.

FIG. 10 is a flowchart showing an example of a process of correcting a haptic presentation signal.

FIG. 11 is a graph for describing an example of analysis of acceleration data.

FIG. 12 is a graph showing an example of the corrected haptic presentation signal.

FIG. 13 is a schematic diagram showing another example of the haptic presentation apparatus and the attachment.

FIG. 14 is a schematic diagram showing another example of the haptic presentation apparatus and the attachment.

FIG. 15 is a schematic diagram showing another example of the haptic presentation apparatus and the attachment.

### MODE(S) FOR CARRYING OUT THE INVENTION

Hereinafter, embodiments according to the present technology will be described with reference to the drawings.

### First embodiment

### [Configuration of Haptic Presentation System]

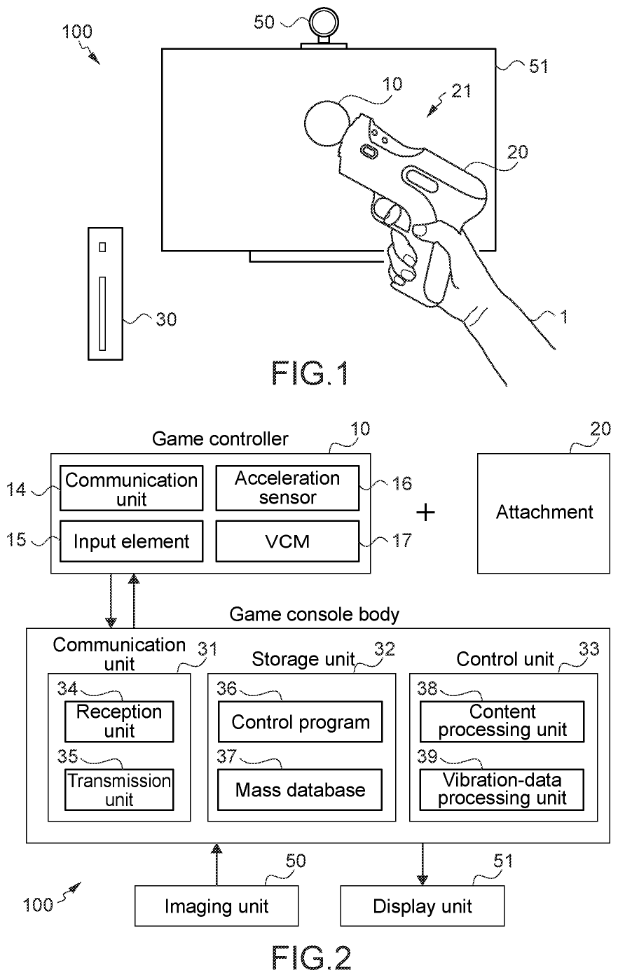

FIG. 1 is a schematic diagram showing an outline of a haptic presentation system according to a first embodiment of the present technology. FIG. 2 is a block diagram showing a configuration example of the haptic presentation system shown in FIG. 1. A haptic presentation system 100 is, for example, a system for providing game content and the like. In the haptic presentation system 100, various types of haptic content according to the operation of a user 1 playing the game content, the progress of the content, and the like are presented to the user 1.

The haptic presentation system 100 includes a game controller 10, an attachment 20, a game console body 30, an imaging unit 50, and a display unit 51. In the example shown in FIG. 1, the game controller 10 on which the attachment 20 is mounted is used. Hereinafter, the game controller 10 on which the attachment 20 is mounted, i.e., a complex of the attachment 20 and the game controller 10 will be referred to as a composite controller 21 in some cases.

For example, an image of game content generated by the game console body 30 is displayed on the display unit 51. The user 1 is capable of proceeding with the game content by performing an input operation using the composite controller 21 (the game controller 10 and the attachment 20) in accordance with the displayed content of the display unit 51. Note that the attachment 20 can be attached/detached to/from the game controller 10 as appropriate during activation of the game console body 30.

Further, in the haptic presentation system 100, for example, the game controller 10 vibrates to present predetermined haptic content to the user 1. More specifically, the vibration of the game controller 10 is transmitted to the user 1 via the attachment 20, whereby a haptic presentation (Haptics presentation) corresponding to the vibration waveform (haptic content) is realized.

Note that, in the present disclosure, the haptic perception (Haptics) is a perception generated by touching an object by a person, for example. For example, the haptic perception includes a feeling when touching an object, a force sense (haptic) received from an object, and the like. Further, the haptic content is content representing the above-mentioned haptic perception, and for example, waveforms, intensity, duration, and the like of vibration are set as parameters of the haptic content. For example, in a game, vibration representing the impact when firing a gun, vibration representing being damaged, or the like becomes haptic content. In addition, the present technology is applicable to arbitrary haptic content.

Hereinafter, a haptic perception presented by using vibration will be mainly described. Further, the haptic content will be referred to simply as the haptic in some cases. In this embodiment, the game controller 10 corresponds to the haptic presentation apparatus. Further, the attachment 20 is an example of a contact body that is in contact with the haptic presentation apparatus.

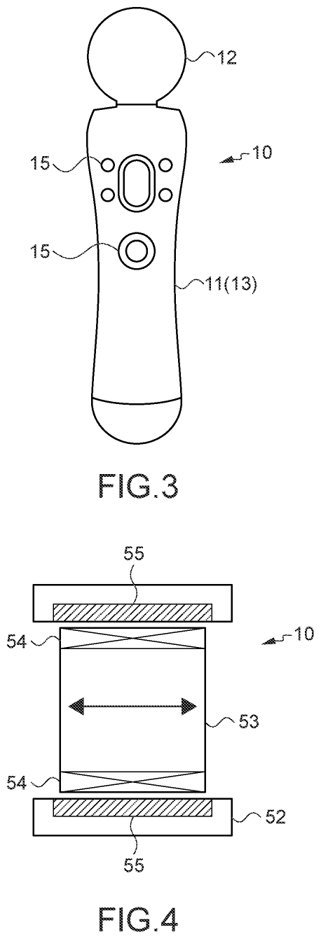

FIG. 3 is a schematic diagram showing an example of the game controller 10. FIG. 3 schematically shows the external appearance of a rod-shaped game controller 10. The game controller 10 is capable of independently communicating with the game console body 30, and has a function of accepting operational inputs by the user 1. The game controller 10 includes a grip portion 11 and a distal end portion 12.

The grip portion 11 is a rod-shaped portion for the user 1 to grip. Further, the grip portion 11 functions as a casing 13 (exterior) of the game controller 10. The distal end portion 12 has a spherical shape and is provided at one end of the grip portion 11. The distal end portion 12 is configured to emit light in a predetermined color as a whole, and functions as a marker such as a motion capture for detecting the motion of the user 1.

For example, the user 1 grasping the game controller 10 (grip portion 11) is imaged by the imaging unit 50 described below. Further, the game console body 30 detects the position and the movement of the distal end portion 12 that emits light of a predetermined color from the image obtained by imaging the user 1. This makes it possible to detect the operation of moving the game controller 10 by the user 1, or the like. In this way, the game controller 10 functions as a marker of the motion controller that performs an operation input by the operation of the user 1.

As shown in FIG. 2, the game controller 10 further includes a communication unit 14, an input device 15, an acceleration sensor 16, and a voice coil motor 17 (VCM).

The communication unit 14 communicates with the game console body 30. For example, the communication unit 14 receives various control signals generated by the game console body 30, and outputs them to the respective units of the game controller 10. Further, for example, the communication unit 14 transmits data generated by the respective units (the input device 15, the acceleration sensor 16, and the like) of the game controller 10 to the game console body 30.

Further, in the case where the attachment 20 capable of communicating with the game controller 10 is mounted, the communication unit 14 performs communication with the attachment 20. For example, the communication unit 14 reads data or the like input by using the attachment 20, and transmits the read data or the like to the game console body 30. Further, in the case where the attachment 20 has the function of executing a predetermined operation (light emission function, vibrating function, etc.), the communication unit 14 receives various control signals generated by the game console body 30, and outputs them to the respective units of the attachment 20. In this way, the attachment 20 and the game console body 30 are capable of communicating with each other via the communication unit 14.

The communication unit 14 (game controller 10) is typically configured to perform wireless communication with the game console body 30 and wired communication with the attachment 20. The communication unit 14 is provided with, for example, a wireless communication module capable of performing predetermined wireless communication such as Bluetooth (registered trademark), a wireless LAN, and WUSB (Wireless USB). In addition, the communication unit 14 is provided with a wired communication module or the like for performing wired communication with the attachment 20 via a predetermined connecting terminal (not shown).

In addition, the specific configuration of the communication unit 14, the communication mode of the game controller 10, and the like are not limited. For example, the game controller 10 and the attachment 20 may be connected to each other by wireless communication. Further, for example, the game controller 10 and the game console body 30 may be connected to each other by wired communication. The communication unit 14 may be appropriately configured in accordance with these communication modes of the game controller 10.

The input device 15 is a device for detecting an operational input of the user 1. In this embodiment, as shown in FIG. 3, a plurality of input devices 15 is provided on the surface of the game controller 10 (grip portion 11). The specific configuration of the input device 15 is not limited. For example, an arbitrary input device such as a button, a switch, a joystick, and a slider may be provided. The input data input by the user 1 via the respective input devices 15 is transmitted to the game console body 30 via the communication unit 14.

The acceleration sensor 16 detects the acceleration of the game controller 10. The acceleration sensor 16 is fixedly located inside the casing 13 of the game controller 10 to detect the acceleration generated in the game controller 10. The specific configuration of the acceleration sensor 16 is not limited. For example, a three-axis acceleration sensor capable of detecting acceleration in three-axis directions (XYZ directions) perpendicular to each other is used. The acceleration data detected via the acceleration sensor 16 is transmitted to the game console body 30 via the communication unit 14.

Note that the game controller 10 is appropriately provided with a gyroscopic sensor, an inertial sensor, or the like in addition to the acceleration sensor 16. The type or the like of the sensor provided on the game controller 10 is not limited. For example, a pressure sensor for detecting the gripping force of the user 1 or a temperature sensor may be provided. In addition, an arbitrary sensor for detecting various states of the game controller 10 may be provided as appropriate.

The voice coil motor 17 (VCM) is a vibrating actuator for haptic presentation and is a linear vibrating actuator including a vibrator that linearly vibrates. In the linear vibrating actuator, a variety of haptic perceptions can be presented by appropriately controlling the amplitude and vibration frequency of the vibrator that linearly moves. Note that as the linear vibrating actuator, an actuator, an LRA (Linear Resonant Actuator), an actuator using a piezoelectric element, or the like capable of providing a pressure-based haptic presentation can be used, in addition to the voice coil motor 17. These linear vibrating actuators are examples of a vibrating device according to this embodiment.

FIG. 4 is a schematic diagram showing a configuration example of the voice coil motor 17. The voice coil motor 17 is supported on the casing 13 of the game controller 10 and is disposed inside the casing 13. The voice coil motor 17 includes a vibrator 52 and a stator 53. The voice coil motor 17 is a linear actuator that generates vibration by reciprocating the vibrator 52 along a predetermined direction with respect to the stator 53. Hereinafter, the direction in which the vibrator 52 moves (right and left direction in the figure) will be referred to as the vibration direction.

The vibrator 52 has, for example, a columnar shape with the vibration direction as an axis. An electric wire or the like is wound around the side surface of the vibrator 52 to form a coil 54. The stator 53 is fixedly disposed in the casing 13 and has a cylindrical space for housing the vibrator 52 movably along the vibration direction. The inner side surface of the cylindrical space, a magnet 55 is disposed with one of the magnetic poles (S pole or N pole) facing the vibrator 52. Further, the vibrator 52 and the stator 53 are connected to each other via an elastic body such as a spring (not shown).

For example, by passing an AC current to the coil 54 of the vibrator 52, the vibrator 52 reciprocates along the vibration direction. The reaction force generated by the reciprocating motion acts on the casing 13 of the game controller 10, and the game controller 10 itself vibrates. As a result, it is possible to perform haptic presentation using vibration for the user 1 grasping the game controller 10 (grip portion 11).

The voice coil motor 17 is driven by, for example, a voltage driving. For example, from a drive source (not shown), a voltage signal for driving the voice coil motor 17 (hereinafter, referred to as the drive signal) is applied to the coil 54. This drive signal is generated on the basis of a control value or the like output from the game console body 30 described below. Note that the present technology is not limited to the case where the voice coil motor 17 is voltage-driven, and, for example, a configuration in which the voice coil motor 17 is current-driven may be employed.

In the voice coil motor 17, for example, by controlling the width and period of the reciprocating motion of the vibrator 52, it is possible to generate vibration at an arbitrary amplitude for a wide frequency band. Thus, the voice coil motor 17 can be said to be a broadband actuator that generates broadband vibration. As a result, it is possible to greatly improve the expression of the haptic perception (Haptics). The operation of the voice coil motor 17 will be described in detail below.

The specific configuration of the voice coil motor 17 is not limited. For example, as shown in FIG. 4, in place of the moving coil type motor in which the coil 54 is formed in the vibrator 52, a moving magnet type motor or the like in which the magnet 55 is disposed in the vibrator 52 may be used. Further, a configuration or the like in which the stator 53 is provided inside the vibrator 52 may be employed. In addition, the size, shape, and the like of the voice coil motor 17 may be appropriately set in accordance with, for example, the size and the like of the game controller 10 to be mounted.

The attachment 20 is, for example, an attachment to be mounted on the game controller 10 Typically, the attachment 20 is disposed in contact with the game controller 10 so that the relative position with the game controller 10 is fixed.

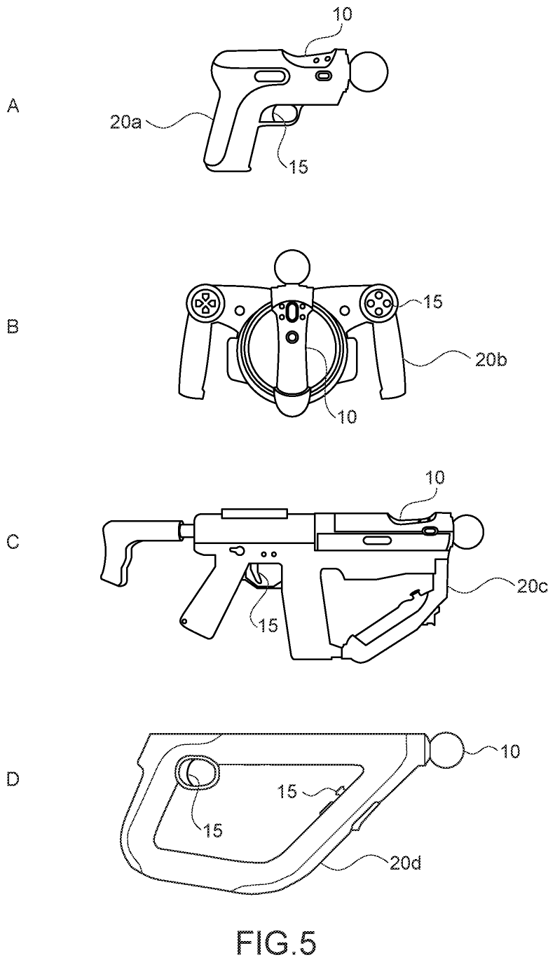

FIG. 5 is a schematic diagram showing an example of the attachment 20. Parts A to D of FIG. 5 schematically show the external appearance of attachments 20a to 20d on which the game controller 10 shown in FIG. 3 is mounted. These attachments 20a to 20d are used as the composite controller 21 with the game controller 10 attached.

The attachment 20a shown in Part A of FIG. 5 has the shape of a hand gun. The attachment 20a is the attachment 20 used by the user 1 in FIG. 1. The game controller 10 is inserted into the distal end (muzzle side) of the attachment 20a and is integrally fixed to the attachment 20a by a fixture provided in the insertion portion. At this time, the game controller 10 is communicably connected to the attachment 20a via a connecting terminal (not shown).

Further, the attachment 20a is provided with a trigger-type input device 15. The trigger-type input device 15 is connected to the game controller 10 via a connecting terminal or the like (not shown). For example, the user 1 is capable of performing a predetermined input operation such as shooting by pulling the trigger (input device 15) while holding the grip of the attachment 20a. In this way, the attachment 20a can be said to have a function of assisting the input operation of the user 1.

The attachment 20b shown in Part B of FIG. 5 has the shape of a grip-type handle. The game controller 10 is inserted between two grips and fixed integrally to the attachment 20b. The attachment 20b is provided with, for example, a plurality of buttons (input devices 15) for inputting moving directions, options, and the like. By using the attachment 20b, for example, input operations in a driving game or the like can be easily executed.

The attachment 20c shown in Part C of FIG. 5 has the shape of a two-handed gun and is provided with a trigger-type input-device 15. The game controller 10 is inserted at the end of the attachment 20c. Note that a different controller other than the game controller 10 can be attached to the attachment 20c. Further, the attachment 20d shown in Part D of FIG. 5 is a two-handed shooting controller, and a stick-type input device 15 or the like is provided in addition to the trigger-type input device 15. For example, such a configuration is also possible.

The attachments 20a to 20d are each the attachment 20 communicably connected to the game controller 10 via a connecting terminal. For example, the attachments 20a to 20d each transmit its own device information in response to a request signal from the game controller 10. That is, these attachments 20 are capable of supplying device information of the corresponding attachment 20. The device information includes, for example, information for specifying the attachment 20 such as the format, model number, manufacturer, serial number, and the like of the attachment 20.

Note that the attachment 20 that does not communicate with the game controller 10 may be used. For example, the attachment 20 includes an external battery having no communication function. Alternatively, the attachment 20 that is not electrically connected to the game controller 10 may be used.

For example, a case, a cover, or the like to be mounted on the game controller 10 is also included in the attachment 20 in the present disclosure. In addition, the specific configuration of the form, type, function, and the like of the attachment 20 is not limited, and for example, an arbitrary object to be mounted on the game controller 10 may be the attachment 20.

With reference to FIG. 2 again, the game console body 30 includes a communication unit 31, a storage unit 32, and a control unit 33. Further, the game console body 30 is provided with the imaging unit 50 and the connecting terminal or the like for connecting the display unit 51 is provided as appropriate.

The communication unit 31 communicates with the game controller 10. The communication unit 31 is appropriately configured so as to be capable of communicating with, for example, the communication unit 14 of the game controller 10. As the communication unit 31, for example, a wireless communication module or the like capable of performing communication in accordance with a wireless communication standard similar to that of the communication unit 14 is used as appropriate. The communication unit 31 includes a reception unit 34 and a transmission unit 35.

The reception unit 34 receives various types of data from the game controller 10, and outputs the received data to the respective units of the game controller 10 as appropriate. For example, input data (button command, etc.) input using the game controller 10 or the input device 15 of the attachment 20 or acceleration data detected by the acceleration sensor 16 is received. Further, for example, device information of the attachment 20 is received. The transmission unit 35 transmits various control signals and command values generated by the control unit 33 described below to the game controller 10.

The storage unit 32 is a non-volatile storage device, and a storage device such as an HDD (Hard Disk Drive) and a flash memory is used. The storage unit 32 stores a control program 36 and the like for controlling the operation of the entire game console body 30.

Further, a mass database 37 is stored in the storage unit 32. In the mass database 37, a list of information (format, model number, etc.) for specifying each of the attachments 20 that can be mounted on the game controller 10 and the mass of the attachment 20 is recorded. The method of installing the control program 36 and the mass database 37 on the game console body 30 is not limited.

The control unit 33 controls the operation of the respective units of the game console body 30, and generates various control signals (a haptic output signal described below, etc.) to be transmitted to the game controller 10. The control unit 33 functions as an information processing apparatus according to this embodiment.

The control unit 33 has a hardware configuration that is necessary for a computer, such as a CPU (Central Processing Unit) and a memory (a RAM (Random Access Memory) and a ROM (Read Only Memory)). An information processing method according to the present technology is realized by the CPU loading the control program 36 according to the present technology stored in the storage unit 32 into the RAM and executing the program.

For example, a PLD (Programmable Logic Device) such as an FPGA (Field Programmable Gate Array), or another device such as an ASIC (Application Specific Integrated Circuit) may be used as the control unit 33.

In this embodiment, the CPU of the control unit 33 executes the control program 36, thereby realizing, as the functional blocks, a content processing unit 38 and a vibration-data processing unit 39. Note that, in order to realize the respective functional blocks, dedicated hardware such as an IC (integrated circuit) may be used as appropriate.

The content processing unit 38 executes various processes that cause game content to proceed. For example, the video and audio of the game content are generated in accordance with the input data input by the user 1, the detected result of the motion capture, and the like.

The content processing unit 38 generates a haptic presentation signal according to haptic content to be presented to the game controller 10. Here, the haptic presentation signal is a signal representing the vibration waveform of the haptic content, typically a signal representing the amplitude and frequency component of the voice coil motor 17 for exciting the game controller 10. As the haptic presentation signal, for example, a signal that includes a control value (input value) for driving the voice coil motor 17 is generated. For example, the vibration of the amplitude and the frequency component (vibration waveform) represented by the haptic presentation signal can be generated by driving the voice coil motor 17 with the control value included in the haptic presentation signal.

In this embodiment, the haptic presentation signal is designed so that a predetermined haptic perception can be presented to the user 1 using the game controller 10 alone. That is, it can be said that the haptic presentation signal is a signal representing the vibration waveform for presenting predetermined haptic content by vibrating the game controller 10 on which the attachment 20 has not been mounted. Note that the content processing unit 38 may be provided in a computer (e.g., an external server apparatus) other than the control unit 33.

The specific configuration of the haptic presentation signal is not limited, and a signal capable of presenting predetermined haptic content may be generated as appropriate in accordance with, for example, the configuration of the voice coil motor 17. Note that as described below, in the haptic presentation system 100, the haptic presentation signal generated by the content processing unit 38 is corrected and used for controlling the voice coil motor 17. Therefore, the haptic presentation signal generated by the content processing unit 38 is not necessarily used as it is for controlling the voice coil motor 17.

The vibration-data processing unit 39 controls the vibration of the game controller 10. In this embodiment, the vibration control of the game controller 10 (drive control of the voice coil motor 17, etc.) according to the attachment 20 mounted on the game controller 10 is executed.

The vibration-data processing unit 39 controls, on the basis of the haptic presentation signal according to haptic content to be presented to the game controller 10 and attachment information regarding the attachment 20 that is contact with the game controller 10, the haptic output signal to be output to the game controller 10. The haptic output signal is, for example, a signal that is to be actually output to the game controller 10 in order to present haptic content. By controlling this haptic output signal, the vibration of the game controller 10 is controlled. In this embodiment, the vibration-data processing unit 39 corresponds to the haptic control unit.

The vibration-data processing unit 39 acquires attachment information regarding the attachment 20 that is in contact with the game controller 10. That is, the vibration-data processing unit 39 acquires attachment information of the attachment 20 that is mounted on the game controller 10 and is in contact with the casing 13 or the like of the game controller 10. In this embodiment, the attachment information corresponds to the contact body information.

Specifically, as the attachment information, mass data regarding the mass of the attachment 20 is acquired. The mass data is typically data indicating the mass (weight) of the attachment 20. In this embodiment, the mass data corresponds to the mass information.

For example, information regarding whether or not an attachment is mounted or device information of the attachment 20 is acquired as the attachment information. For example, on the basis of these pieces of information, the mass data of the attachment 20 is read from the mass database 37 or the like. Alternatively, the mass data of the attachment 20 is calculated on the basis of the detection result of the acceleration sensor 16 of the game controller 10, or the like. The method of acquiring the mass data of the attachment 20 will be described in detail below.

Further, in this embodiment, the vibration-data processing unit 39 controls the haptic output signal on the basis of the correction information and the haptic presentation signal, the correction information being used to correct the haptic presentation signal on the basis of the attachment information. For example, the signal obtained by correcting the haptic presentation signal using the correction information is the haptic output signal. That is, the haptic output signal is generated by correcting the haptic presentation signal.

The correction information is information for correcting the haptic presentation signal, and is calculated on the basis of the above-mentioned mass data, for example. As the correction information, for example, the ratio (magnification, etc.) of correcting the amplitude and the frequency component represented by the haptic presentation signal, and the correction amount are calculated. Further, for example, a default correction amount or the like set in accordance with the type or the like of the attachment 20 may be used as the correction information. Hereinafter, correcting the haptic presentation signal on the basis of the correction information will be referred to simply as correcting the haptic presentation signal.

For example, the correction information is calculated using the mass data, which is attachment information, and the haptic presentation signal is corrected using the correction information. That is, a haptic output signal in which the vibration waveform (haptic presentation signal) of the voice coil motor 17 has been corrected in accordance with the mass of the attachment 20 is generated. The generated haptic output signal is transmitted to the game controller 10 via the transmission unit 35 of the communication unit 31. Then, by the drive source of the voice coil motor 17, a drive signal (voltage signal) is generated on the basis of the haptic output signal, and applied to the coil 54 of the voice coil motor 17. As a result, the drive control of the voice coil motor 17 can be executed.

Typically, the drive signal to be applied to the voice coil motor 17 will be a signal having a waveform similar to that of the haptic output signal. Therefore, it can be said that the vibration-data processing unit 39 controls the waveform of the drive signal or the like and controls the vibration of the voice coil motor 17 by correcting the original vibration waveform (haptic presentation signal). The method of calculating the correction information and the method of correcting the haptic presentation signal will be described in detail below.

The imaging unit 50 images the user 1 using the game controller 10 (attachment 20). The image of the user 1 is appropriately output to the game console body 30, and is used for a motion-capturing process of the user 1, or the like. Note that there may be a case where game content or the like that can progress without using the imaging unit 50 is played. Even in such a case, the present technology is applicable.

As the imaging unit 50, for example, a digital camera including an image sensor such as a CMOS (Complementary Metal-Oxide Semiconductor) sensor and a CCD (Charge Coupled Device) sensor is used. Further, for example, a distance sensor such as a TOF (Time of Flight) camera and a stereoscopic camera may be used as the imaging unit 50.

The display unit 51 displays, for example, an image generated by the content processing unit 38. In the example shown in FIG. 1, a stationary display is schematically illustrated as the display unit 51. The specific configuration of the display unit 51 is not limited. For example, an immersion-type or see-through-type HMD (Head Mount Display) may be used as the display unit 51.

### [Vibration Model of Voice Coil Motor]

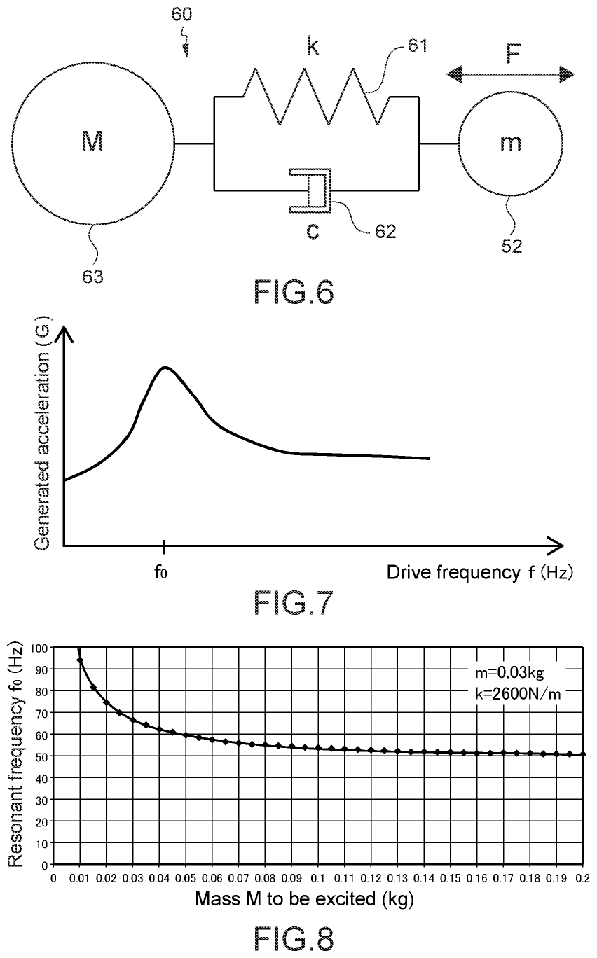

FIG. 6 is a schematic diagram showing a vibration model of the vibration system to which the voice coil motor 17 is connected. The vibration characteristics of the voice coil motor 17 will be described below with reference to a vibration model 60 shown in FIG. 6.

The vibration model 60 (vibration system) includes the vibrator 52, a spring portion 61, a damper portion 62, and a vibration target 63. The vibrator 52 is the vibrator 52 (see FIG. 4) of the voice coil motor 17, and is a mass body (vibrator) reciprocating in a predetermined direction. In the voice coil motor 17, an exciting force F (arrow in the figure) acts on the vibrator 52 along a predetermined direction, and thus, the vibrator 52 is vibrated.

The spring portion 61 is an elastic body that connects the vibrator 52 and the stator 53 (the casing 13 of the game controller 10) to each other. The damper portion 62 is an element that generates a damping force that damps the vibration of the vibrator 52. As shown in FIG. 6, in the vibration model 60, the spring portion 61 and the damper portion 62 are disposed in parallel between the vibrator 52 and the vibration target 63. In other words, the vibrator 52 and the vibration target 63 are connected to each other by the spring portion 61 and the damper portion 62 disposed in parallel.

The vibration target 63 is an object to be excited by the voice coil motor 17. For example, in the case where the attachment 20 is mounted, a part obtained by removing the vibrator 52 from the game controller 10 and the attachment 20 (the composite controller 21) becomes the vibration target 63. Hereinafter, the mass of the vibrator 52 will be referred to as m, and the mass of the vibration target 63 will be referred to as M. Further, the spring coefficient of the spring portion 61 will be referred to as k, and the damper coefficient of the damper portion 62 will be referred to as c.

FIG. 7 is a graph showing an example of vibration characteristics of the vibration system to which the voice coil motor 17 is connected. The horizontal axis of the graph represents a driving frequency f (Hz) of the voice coil motor 17 and is, for example, the vibration period of the vibrator 52. The vertical axis of the graph represents an acceleration a (G) generated in the vibration target 63. FIG. 7 shows, for example, the acceleration a generated in the vibration target 63 in each period of the drive signal in the case where the voice coil motor 17 is driven using a drive signal (Sin-wave, etc.) having a constant amplitude. Hereinafter, the acceleration a generated in the vibration target 63 will be referred to as the generated acceleration a.

As shown in FIG. 7, the voice coil motor 17 has a particular resonant frequency f₀ according to the vibration system. For example, by performing the driving of the voice coil motor 17 in the resonant frequency f₀, it is possible to generate the largest vibrational acceleration. That is, in the case where the amplitude of the drive signal is constant, by setting the period of the drive signal to the resonant frequency f₀, it is possible to maximize the acceleration a generated in the vibration target 63.

For example, in the case where a game designer presents vibration content with a strong sense of experience, a haptic presentation signal containing many components of the resonant frequency f₀ is generated to vibrate the voice coil motor 17. This makes it possible to present, for example, a powerful gun-firing feeling. In this way, by performing the game design considering the frequency characteristics of the voice coil motor 17 (actuator), excellent amusement performance can be exhibited.

For example, as shown in FIG. 1 or FIG. 5, in the case where the attachment 20 for function extension or the like is mounted on the game controller 10 equipped with the voice coil motor 17, the frequency characteristics of vibration in the vibration system change. As factors of the change in frequency characteristics, for example, the following two factors are considered.

The first factor is a decrease in the generated acceleration a due to an increase in the mass excited by the voice coil motor 17. For example, mounting the attachment 20 on the game controller 10 increases the mass M of the vibration target 63 of the voice coil motor 17. With the increase of the mass M, the acceleration a generated in the vibration target 63 decreases.

The mass of the game controller 10 excluding the mass m of the vibrator 52 of the voice coil motor 17 is denoted by M1, and the mass of the attachment 20 is denoted by M2. For example, in the case where the attachment 20 is not mounted, the mass of the vibration target 63 is M=M1. Further, for example, in the case where the attachment 20 is mounted, the mass of the vibration target 63 is M=M1+M2. Note that the total mass of the vibration system (the game controller 10 and the attachment 20) is M+m.

In the vibration target 63, the acceleration a is generated by the exciting force F of the voice coil motor 17 so as to satisfy the relationship F=M·a.

Therefore, in the case where the attachment 20 is mounted, the generated acceleration a is expressed by the following formula.

$$a = F / M = F / ( M 1 + M 2 ) \qquad ( 1 )$$

As shown in the formula (1), the generated acceleration a has a generally inversely-proportional relationship with respect to the increase of the mass M to be excited. That is, as compared with the case of exciting the game controller 10 alone (M=M1), the generated acceleration a decreases to be substantially inversely proportional to the increase (M2) of the mass M in the case where the attachment 20 is mounted (M=M1+M2).

As described above, when the attachment 20 is mounted and the mass of the vibration target 63 increases, the acceleration a generated by the voice coil motor 17 decreases. Note that actually, the exciting force F of the voice coil motor 17 also changes in accordance with a change in the resonant frequency f₀ described below. Therefore, the relationship between the generated acceleration a and each mass becomes a more complex relationship.

The second factor is a decrease in the resonant frequency f₀ of the vibration system due to an increase in the mass excited by the voice coil motor 17. For example, by mounting the attachment 20, the resonant frequency f₀ (see FIG. 7) where the generated acceleration a is maximized is shifted to the lower frequency.

The resonant frequency f₀ of the vibration system excited by the voice coil motor 17 is expressed by the following formula using a spring coefficient k of the spring portion 61 shown in FIG. 6.

$${f}_{0} = sqrt ( k / {M}^{′} ) = ( k / {M}^{′} ) ⋀ ( 1 / 2 ) \qquad ( 2 )$$

Here, M′ represents a parameter called a reduced mass, and is expressed by M′= (m·M)/(m+M). Note that the effect of the damping force applied by the damper portion 62 for damping the vibration is ignored in the formula (2), and the formula (2) does not include a damper coefficient c and the like.

FIG. 8 is a graph showing an example of the relationship between the mass M of the vibration target 63 and the resonant frequency f₀ of the vibration system. The horizontal axis of the graph represents the mass M (kg) of the vibration target 63, and the vertical axis of the graph represents the resonant frequency f₀ (Hz) of the vibration system. FIG. 8 shows the characteristics of the resonant frequency f₀ calculated on the basis of the above-mentioned formula (2) with respect to the mass M. Note that the mass m of the vibrator 52 is set to 0.03 kg, and the spring coefficient k of the spring portion 61 is set to 2600 N/m.

For example, in the case where the mass m of the vibrator 52 is sufficiently low relative to the mass M of the vibration target 63, the reduced mass M′ can be regarded as a substantially constant value with respect to an increase in the mass M. Meanwhile, the mass m of the vibrator 52 is set to be large in order to obtain a large generated acceleration a in the game controller 10. In such a case, the mass m of the vibrator 52 cannot be ignored. As a result, for example, as shown in the graph of FIG. 8, the resonant frequency f₀ decreases with respect to an increase in the mass M of the vibration target 63.

For example, in the case where the mass M1 of the game controller 10 excluding the vibrator 52 is 0.1 Kg, the resonant frequency f₀ of the game controller 10 alone is approximately 53.4 Hz. Assumption is made that the attachment 20 is mounted on this game controller 10. In the case where the mass M2 of the attachment 20 is 0.1 kg, the mass M of the vibration target 63 is 0.2 kg. In this case, the resonant frequency f₀ in the game controller 10 on which the attachment 20 is mounted is approximately 50.2 Hz. That is, in this vibration system, the resonant frequency f₀ decreases by approximately 3 Hz by adding the attachment 20 of 0.1 kg.

As described above, the vibrational characteristics of the system of the game controller 10+the attachment 20 change by connecting the attachment 20 to the game controller 10 on which the voice coil motor 17 is mounted. That is, the generated acceleration a decreases by an increase in the mass M to be excited. The generated acceleration a has a relationship generally inversely proportional to the increase in the mass M as shown in the formula (1). Further, the resonant frequency f₀ changes due to the change in the vibration system. The resonant frequency f₀ as a system decreases as the mass M to be vibrated increases, as shown in the formula (2).

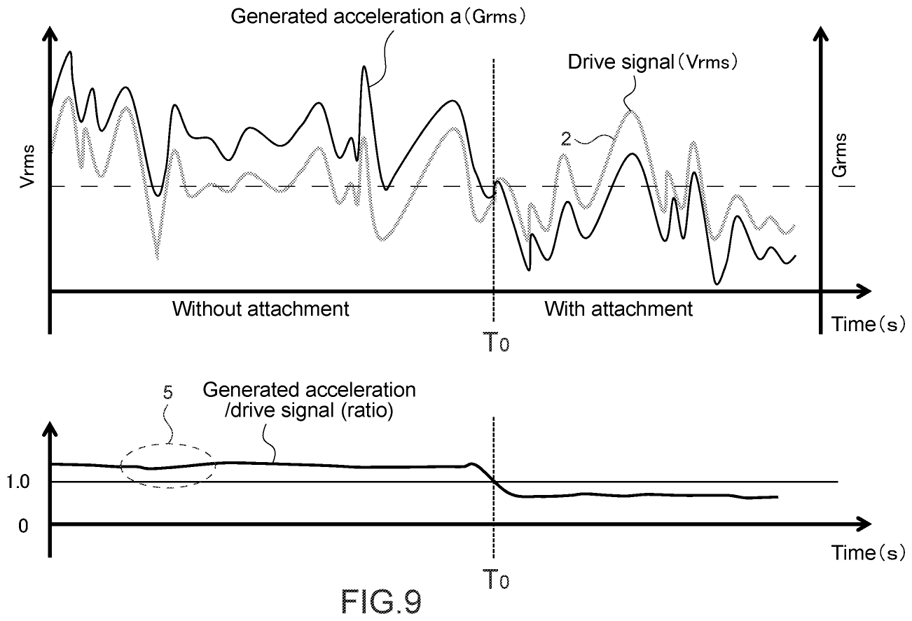

FIG. 9 is a graph showing the relationship between the generated acceleration a and an input-voltage V before and after the mounting of the attachment 20. The upper graph of FIG. 9 shows the temporal change in a drive signal 2 (input voltage) for driving the voice coil motor 17 and the acceleration a generated in the vibration target 63. The horizontal axis of the graph is time(s). Further, the vertical axes on the left and right sides respectively represent the effective values (root mean square: rms) of the drive signal 2 (V) and the generated acceleration a (G) at the respective timings.

For example, the orientation of the acceleration generated by the vibration changes in accordance with the vibration period, and the sign of the acceleration is constantly replaced. Therefore, in the upper graph of FIG. 9, the magnitude of the generated acceleration a is shown by plotting the effective value within a predetermined time period of the generated acceleration a. Note that both the generated acceleration a and the drive signal 2 are appropriately adjusted so as to be plotted with reference to a predetermined reference level (rough wavy lines in the figure).

In the upper graph of FIG. 9, the attachment 20 is mounted on the game controller 10 at a certain timing T₀. That is, during the period in which the relationship of the time T<T₀ is satisfied, the game controller 10 alone is excited. In the period in which the relationship of the time T>T₀ is satisfied, the game controller 10 (the composite controller 21) on which the attachment 20 is mounted is excited. Note that in FIG. 9, assumption is made that the correction of the drive signal 2, i.e., the correction of the haptic presentation signal, and the like are not performed before and after the mounting of the attachment 20.

For example, since the effective value (intensity) of the drive signal 2 is appropriately set in accordance with the progress of the game content, a random temporal change is shown. The upper graph of FIG. 9 shows how the effective value of the drive signal 2 randomly changes around the reference level. Note that since the correction of the drive signal 2 (haptic presentation signal), and the like are not executed, the range of values that the effective value of the drive signal 2 can take (range of random changes), and the like do not change even after mounting the attachment 20, and vibration control similar to that before the mounting is executed.

When the voice coil motor 17 is driven by the drive signal 2, the generated acceleration a is generated. Therefore, the waveform of the effective value of the generated acceleration a becomes a waveform similar to the waveform of the effective value of the drive signal 2. Note that the generated acceleration a changes mainly in a range higher than the reference level during a period in which the attachment 20 is not mounted (T<T₀). Meanwhile, during the period in which the attachment 20 is mounted (T≥T₀), the range in which the generated acceleration a changes shifts to a range lower than the reference level. That is, when the attachment 20 is mounted, the level of the generated acceleration a decreases.

The lower graph of FIG. 9 is a graph showing the ratio of the generated acceleration a and the drive signal 2 in the upper graph of FIG. 9 (generated acceleration a/drive signal 2). This ratio can be said to be the ratio at which the drive signal 2 is converted into acceleration in the vibration system.

For example, at a time point before the attachment 20 is mounted, the ratio of the generated acceleration a and the drive signal 2 has an approximately constant value. Note that the change in the gripping force of the user 1, or the like changes the vibration conditions of the vibration system, or the like in some cases. In such a case, there is a possibility that the ratio of the generated acceleration a and the drive signal 2 changes somewhat.

Further, when the attachment 20 is mounted, the generated acceleration a decreases as compared with that before the mounting. For this reason, the ratio of the generated acceleration a and the drive signal 2 also decreases, and converges to a predetermined level corresponding to the mass of the attachment 20, or the like. As described above, in the case of not controlling the level of the drive signal 2 (haptic presentation signal), there is a possibility that the generated acceleration a decreases when the attachment 20 is mounted on the game controller 10.

### [Process of Correcting Haptic Presentation Signal]

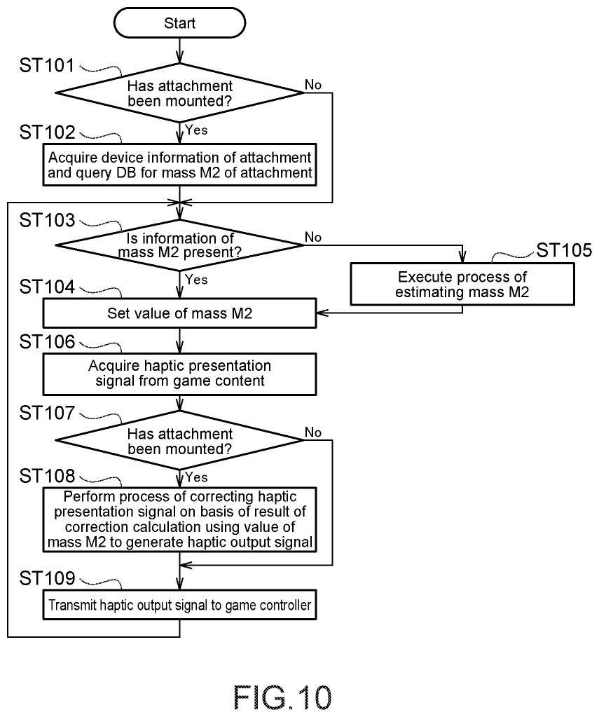

FIG. 10 is a flowchart showing an example of a process of correcting a haptic presentation signal. The flowchart shown in FIG. 10 shows a loop process repeatedly executed during the operation of the game console body 30, for example. For example, the loop process is started at the same time as activating the game console body 30 or starting the game content. Alternatively, the loop process may be started in the case where a mode in which the haptic presentation signal is corrected, or the like is selected by the user 1.

Whether or not the attachment 20 is mounted is determined (Step 101). For example, assumption is made that the attachment 20 capable of communicating with the game controller 10 is mounted. In this case, the game controller 10 transmits a confirming signal indicating that communication with the attachment 20 has been established to the game console body 30 (reception unit 34). The fact that the attachment 20 has been mounted can be determined by receiving this confirming signal.

Further, for example, a predetermined system UI (User Interface) may be displayed on the display unit 51, and the user 1 himself/herself may select the model of the attachment 20 from the system UI. That is, a configuration in which the user 1 himself/herself can explicitly input the fact that the attachment 20 has been mounted may be adopted. For example, in the case where the model of the attachment 20 is selected, it is determined that the attachment 20 has been mounted.

Further, for example, whether or not the attachment 20 has been mounted is determined on the basis of the detection result of the acceleration a generated in the game controller 10. In this case, the detection result (acceleration data) of the acceleration sensor 16 mounted on the game controller 10 is transmitted to the game console body 30. Then, the vibration-data processing unit 39 analyzes the acceleration data and determines whether or not the attachment 20 has been mounted.

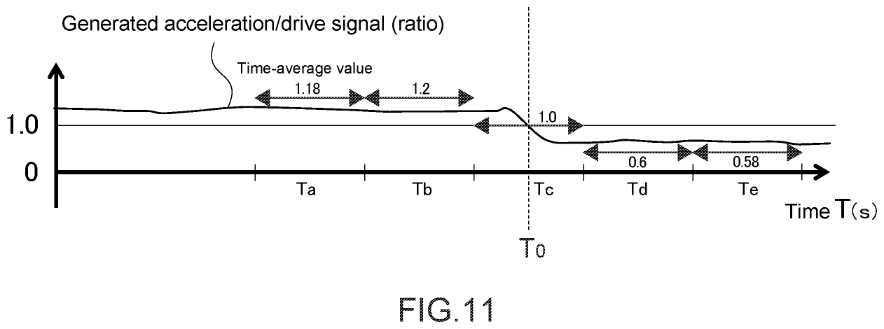

FIG. 11 is a graph for describing an example of analysis of the acceleration data. FIG. 11 shows a graph similar to the lower graph of FIG. 9. The vibration-data processing unit 39 calculates the time-average value within a predetermined period, of the ratio of the generated acceleration a and the drive signal 2 (input voltage). The period during which the average value is calculated is not limited, and may be appropriately set in accordance with, for example, the detection accuracy of the generated acceleration a, the noise level, or the like.

In FIG. 11, five time periods Ta to Te for which the time-average values are calculated are schematically illustrated using arrows. The time periods Ta to Te are, for example, time periods consecutively set in this order so that the time ranges do not overlap. In the example shown in FIG. 11, the attachment 20 is mounted during the time period Tc. Therefore, in the time periods Ta and Tb, the time-average value before the attachment 20 is mounted is calculated. In the time periods Td and Te, the time-average value after the attachment 20 is mounted is calculated. The time-average values calculated in the time periods Ta to Te are 1.18, 1.2, 1.0, 0.6, and 0.58, respectively.

In the vibration-data processing unit 39, for example, the time-average value of the ratio of the generated acceleration a and the drive signal 2 greatly changes, and it is determined that there has been an addition of the attachment 20 at the converged timing. For example, it is determined that the attachment 20 has been mounted in the case where, for example, the time-average value decreases beyond a predetermined threshold value and the level of the time-average value does not return thereafter. In FIG. 11, for example, a decrease in the time-average value is detected in the time period Tc or Td, and it is determined that the attachment 20 has been mounted in the time period Te. As a result, whether or not the attachment 20 has been mounted can be reliably determined.

With reference to FIG. 10 again, in the case where it is determined that the attachment 20 has been mounted (Yes in Step 101), the device information of the attachment 20 is acquired, and the process of querying the mass database 37 for the mass M2 of the attachment 20 is executed (Step 102).

For example, in the case where the attachment 20 capable of communicating with the game controller 10 is connected, the device information of the connected attachment 20 obtained from the extension terminal of the game controller 10 is transmitted to the reception unit 34 of the game console body 30. Then, the vibration-data processing unit 39 refers to the mass database 37, and executes a process of inquiring about the mass M2 of the attachment 20 corresponding to the format or model number included in the device information.

Further, in the case where, for example, the model of the attachment 20 is selected by the user 1 via the system UI, the mass database 37 is referred to on the basis of the information regarding the selected model. Further, the present technology is not limited to the case of referring to the mass database 37. For example, an external database connected to a predetermined network to which the game console body 30 is connectable via the communication unit 31 may be referred to as appropriate. Note that as described with reference to FIG. 11, when it is determined, on the basis of the generated acceleration a, or the like, that the attachment 20 has been mounted, the process of inquiring about the mass M2, or the like is not executed.

In the case where it is determined that the attachment 20 has not been mounted (No in Step 101), the inquiry of the mass M2 of the attachment 20, or the like is not executed and Step 103 is executed.

In Step 103, it is determined whether or not information (mass data) of the mass M2 of the attachment 20 is present. In the case where the mass data of the attachment 20 is present (Yes in Step 103), the mass data of the attachment 20 is read and the value of the mass M2 is set (Step 104).

For example, in the case where the attachment 20 corresponding to the device information is present in the mass database 37 or the like, the mass data of the attachment 20 is read by the vibration-data processing unit 39, and the mass M2 of the attachment 20 is set. In this way, the vibration-data processing unit 39 acquires the mass data on the basis of the device information of the attachment 20. As a result, the mass M2 of the attachment 20 can be easily acquired with high accuracy.

Further, for example, in the case where the model of the attachment 20 is selected by the user 1, the mass data of the selected model is read from the mass database 37 or the like. In this way, the mass data may be acquired by the vibration-data processing unit 39 on the basis of the input information input by the user 1. As a result, for example, even in the case where the attachment 20 that does not provide the device information (the attachment 20 that does not include an additional battery or a connecting terminal, or the like) is used, the mass M2 of the attachment 20 can be appropriately set.

Note that there may be a situation in which the mass data of the attachment 20 cannot be acquired because the attachment 20 is a non-authentic product or the like. In such a case, a process of estimating the mass M2 of the attachment 20 is executed in Step 105 described below. Alternatively, the connection of the attachment 20 as described above may be recognized by a UI operation of the user 1, or the like, and a default mass (e.g., 100 g) may be set as the mass M2. For example, such a process is also possible.

In the case where the mass data of the attachment 20 is not present (No in Step 103), a process of estimating the mass M2 of the attachment 20 is performed (Step 105). Hereinafter, the process of estimating the mass M2 will be referred to as the M2 estimation program.

In the M2 estimation program, the mass data is calculated by the vibration-data processing unit 39 on the basis of the detection result of the acceleration sensor 16. That is, the acceleration sensor 16 in the game controller 10 is used to estimate the mass M2 of the attachment 20.

In this embodiment, test data in the case where the game controller 10 alone is vibrated while the attachment 20 has not been mounted is stored in advance. Specifically, the parameter of the waveform of the test signal for vibrating the voice coil motor 17 (test waveform) and the acceleration a generated in the game controller 10 alone in the case of being vibrated in response to the test signal (hereinafter, referred to as the pre-mounting acceleration) are stored as the test data.

The test signal is a signal for estimating the mass M2. As the test waveform of the test signal, for example, an arbitrary waveform such as a Sin waveform and a triangular waveform is used. The shape, period, amplitude, and the like of the test waveform are not limited. The pre-mounting acceleration is appropriately measured before shipment of the commodity, for example. In this case, the pre-mounting acceleration may be measured for each game controller 10. As a result, it is possible to suppress the effect of individual difference of the game controller 10. Alternatively, the same pre-mounting acceleration may be set for the game controller 10 of the same model.

The test data (the test waveform and the pre-mounting acceleration) is stored in, for example, a memory or the like in the game controller 10, and becomes a value known as a system at the time of shipment of the commodity. In addition, the method of storing the test data, the timing, and the like are not limited. For example, a process of detecting and storing the pre-mounting acceleration may be executed at an arbitrary timing before the M2 estimation program. In this embodiment, the test signal corresponds to the predetermined vibration signal and the pre-mounting acceleration corresponds to the second acceleration.

In the M2 estimation program, in the case where connection of the attachment 20 is detected, a voltage signal (test signal) of the test waveform is applied to the voice coil motor 17 by the vibration-data processing unit 39 for calculating the mass M2. That is, the vibration-data processing unit 39 causes the voice coil motor 17 to vibrate with the test waveform.

At this time, the acceleration a generated in the game controller 10 (hereinafter, referred to as the post-mounting acceleration) is detected by the acceleration sensor 16. Therefore, the acceleration sensor 16 detects the post-mounting acceleration generated in the game controller 10 on which the attachment 20 has been mounted in response to the test signal. In this embodiment, the post-mounting acceleration corresponds to the first acceleration.

Further, the vibration-data processing unit 39 refers to the test data stored in advance, and acquires the pre-mounting acceleration generated in the game controller 10 on which the attachment 20 has not been mounted, in response to the test signal. Then, the mass data is calculated on the basis of the post-mounting acceleration and the pre-mounting acceleration.

In this embodiment, an increase of the mass of the vibration target 63 before and after the mounting of the attachment 20, i.e., the mass M2 of the attachment 20, is calculated in accordance with the inverse proportional relationship of the formula (1) between the generated acceleration a and the mass of the vibration target 63. Note that assumption is made that the exciting force F generated in the voice coil motor 17 by applying the test waveform before and after the mounting of the attachment 20 is substantially constant. Hereinafter, a concrete description will be given.

For example, assumption is made that the pre-mounting acceleration generated in the game controller 10 alone when a voltage of 6 Vpp (test signal) is applied to the voice coil motor 17 while the attachment 20 has not been mounted is 3 Gpp. Note that Vpp and Gpp represent, for example, the maximum amplitude from the minimum value to the maximum value in the test waveform and acceleration.

Further, assumption is made that the same voltage of 6 Vpp (test signal) as that before the mounting is applied to the voice coil motor 17 while the attachment 20 has been mounted, and the post-mounting acceleration of 2 Gpp is detected. That is, assumption is made that the mass of the vibration target 63 increases by the mounting of the attachment 20, and the generated acceleration a decreases from the pre-mounting acceleration 3 Gpp to the post-mounting acceleration 2 Gpp.

In this case, on the basis of the formula (1), the mass of the vibration target 63 excited by the voice coil motor 17 has increased by 1.5 times after the mounting of the attachment 20. That is, the mass M1+M2 of the vibration target 63 after the mounting of the attachment 20 is 1.5×M1. Therefore, the mass M2 of the attachment 20 is calculated as M2=0.5×M1.

As described above, by detecting the acceleration generated by the test waveform before and after the mounting of the attachment 20, the mass data (mass M2) of the attachment 20 is estimated. As a result, for example, the mass M2 can be calculated with high accuracy for an arbitrary attachment 20.

Note that in the case where the user 1 grips the game controller 10, there may be a case where the virtual mass of the controller changes in accordance with the magnitude of the gripping force of the user 1. For example, in accordance with the strength of the gripping force, the controller is less likely to shake and the virtual mass increases in some cases.

For this reason, as described above, it is desirable that the process (M2 estimation program) of estimating the mass M2 of the attachment 20 from the generated acceleration a is performed in a non-gripping state in which the user 1 releases the hand therefrom. As a result, it is possible to estimate the mass M2 of the attachment 20 with high accuracy while avoiding, for example, the effect of increasing the virtual mass due to the gripping force of the user 1.

Further, assumption is made that the user 1 releases the hand and the composite controller 21 (the game controller 10 and the attachment 20) is placed on a hard desk or the like. In this case, when the composite controller 21 vibrates, there may be a case where contact and non-contact with the desk are repeated. As a result, for example, there is a possibility that the acceleration output containing a lot of noise components is detected in response to the voltage input of the test signal such as a Sin waveform.

Therefore, for example, it is desirable to refer to the correlation between the test signal and the generated acceleration a and estimate the mass M2 of the attachment 20 in the case where the test signal and the generated acceleration a have similar waveforms. Such a situation is realized in the case where, for example, the composite controller 21 is placed on a soft surface such as a sofa and a carpet. As a result, the acceleration sensor 16 is capable of detecting the acceleration corresponding to the test signal with high accuracy, and it is possible to improve the accuracy of estimation of the mass M2, for example.

For example, when the estimation process of the M2 estimation program is executed, a message (voice, image, or the like) is presented to the user 1 to inform the user that he/she should release the hand from the composite controller 21 and place the composite controller 21 on a soft surface. This makes it possible to execute the M2 estimation program with high accuracy. It goes without saying that the M2 estimation program may be executed while the user 1 holds the composite controller 21.

Further, as the M2 estimation program, the process of estimating the mass M2 of the attachment 20 may be executed without generating vibration using the test signal. In this case, the vibration-data processing unit 39 calculates the mass data on the basis of to the temporal change in the acceleration detected by the acceleration sensor 16.

For example, as described with reference to FIG. 11, the ratio of the generated acceleration a and the drive signal 2 greatly changes before and after the mounting of the attachment 20. For example, in the time period Ta in which the attachment 20 has not been mounted, the time-average value of the ratio of the generated acceleration a and the drive signal 2 (the generated acceleration a/the drive signal 2) is 1.18. Further, in the time period Te in which the attachment 20 is mounted, the time-average value is 0.58.

This can be said to be a condition in which the level of the acceleration a generated in the composite controller 21 decreases from 1.18 to 0.58 before and after the mounting of the attachment 20 with respect to the drive signal 2 of the same level, for example. Therefore, the decrease rate α=(a₁/a₀) of the generated acceleration a₁ after the attachment 20 is mounted with respect to the generated acceleration a₀ before the attachment 20 is mounted is 0.58/1.18≈1/2.

Further, in accordance with the formula (1), the generated accelerations a₀ and a₁ before and after the mounting of the attachment 20 are expressed as a₀=F/M1 and a₁=F/(M1+M2), respectively. Therefore, the decrease rate α is expressed by the following formula.

$$α = {a}_{1} / {a}_{0} = M 1 / ( M 1 + M 2 ) \qquad ( 3 )$$

As described above, in the example shown in FIG. 11, α≈1/2. That is, (M1+M2)≈2×M1, and it can be seen that the mass M1+M2 after the mounting of the attachment 20 has increased twice as much as that before the mounting. In this case, the mass M2 of the mounted attachment 20 (the increase of the mass) is estimated to be M2˜M1.

In addition, the specific process and the like of the M2 estimation program are not limited. For example, an arbitrary process capable of estimating the mass M2 of the attachment 20 may be executed. When the estimation process by the M2 estimation program is completed, Step 104 is executed, and the estimation result is set as the value of the mass M2.

When the mass M2 of the attachment 20 is set, the content processing unit 38 generates a haptic presentation signal for the voice coil motor 17 according to the progress state of the game content, and outputs the generated haptic presentation signal to the vibration-data processing unit 39 (Step 106).

As described with reference to FIG. 2, the content processing unit 38 generates a haptic presentation signal for presenting a predetermined haptic perception. For example, in accordance with the progress of the game content, data of vibration waveforms designed to present a predetermined haptic perception is read as appropriate, and a haptic presentation signal is generated. Alternatively, a haptic presentation signal may be generated directly in accordance with the progress of the game content.

For example, the haptic presentation signal is designed to present a haptic perception when a bullet or the like is fired, a haptic perception when receiving damage, or the like in the game content. Note that the haptic presentation signal is designed on the assumption that, for example, the game controller 10 is used alone. Therefore, it can be said that the content processing unit 38 generates the control value (input value) of the voice coil motor 17 in the case where the game controller 10 is used alone. The generated haptic presentation signal is appropriately acquired by the vibration-data processing unit 39.

When the haptic presentation signal is acquired, whether or not the attachment 20 has been mounted is determined (Step 107). As shown in FIG. 10, this determination process is a process for determining whether or not the attachment 20 has been mounted in the loop process from Steps 103 to 109.

The determination of whether or not the attachment 20 has been mounted is performed, for example, in the same manner as the process described in Step 101. In the case where it is determined that the attachment 20 has been mounted (Yes in Step 107), the haptic presentation signal is corrected and the haptic output signal is generated (Step 108).

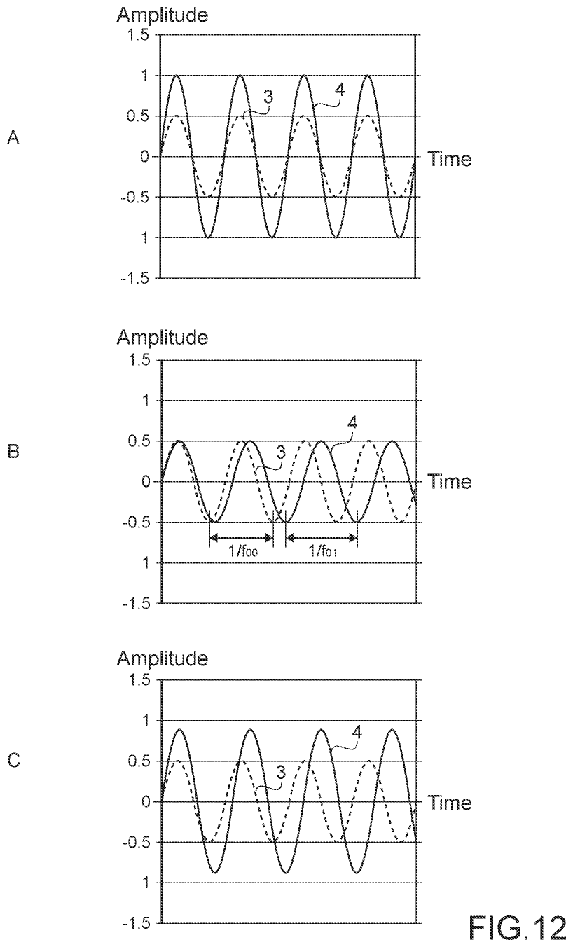

FIG. 12 is a graph showing an example of the corrected haptic presentation signal. In Part A of FIG. 12 to Part C of FIG. 12, a haptic presentation signal 3 (dotted line) generated by the content processing unit 38 and a haptic output signal 4 (solid line) obtained by correcting the haptic presentation signal 3 are plotted. Although the haptic presentation signal 3 is represented by a Sin waveform as an example, the present technology is applicable regardless of the waveform of the haptic presentation signal 3.

As described with reference to the formula (1) and the formula (2), the mounting of the attachment 20 changes the vibration properties of the vibration system including the voice coil motor 17. In this embodiment, the haptic presentation signal 3 is corrected so that substantially the same vibration as that before the mounting of the attachment 20 is realized with respect to such a change in vibration characteristics. Specifically, the correction information regarding at least one of the amplitude and the frequency component represented by the haptic presentation signal 3 is generated on the basis of the attachment information such as mass data. Then, the haptic presentation signal 3 is corrected on the basis of the correction information, and the haptic output signal 4 is generated.

In Part A of FIG. 12, a graph showing an example of the haptic output signal 4 calculated by correcting the amplitude of the haptic presentation signal 3 is shown. Hereinafter, the process of correcting the amplitude of the haptic presentation signal 3 will be described.

In general, the exciting force F acting on the vibration target 63 is expressed as F=k×X using an amplitude (displacement) X of the vibrator 52 and a spring constant k. Therefore, from the formula (1), the generated acceleration a =kX/M. This amplitude X of the vibrator 52 can be controlled by adjusting the amplitude of the haptic presentation signal 3. That is, by correcting the amplitude of the haptic presentation signal 3, it is possible to control the magnitude of the generated acceleration a.

In this embodiment, the amplitude of the haptic presentation signal 3 is corrected so that the generated acceleration a₁ after the attachment 20 is mounted becomes substantially equal to the generated acceleration a₀ before the attachment 20 is mounted. First, the decrease rate α of the generated acceleration a shown in the formula (3) derived on the basis of the formula (1) is calculated.

For example, the decrease rate α=M1/(M1+M2) is calculated using the mass M1 (predetermined value) of the game controller 10 excluding the vibrator 52 and the mass M2 (mass data) of the attachment 20. That is, the decrease rate α of the acceleration generated in the game controller 10 by the vibration of the voice coil motor 17 along with the attachment of the attachment 20 is calculated on the basis of the mass data. In this embodiment, the decrease rate α corresponds to the rate of change.

the magnitude of the haptic presentation signal 3 is multiplied by the inverse of the calculated decrease rate α, and thus, the amplitude of the haptic presentation signal 3 is corrected. In this case, the inverse of the decrease rate α is correction information regarding the magnitude of the haptic presentation signal 3. This process corresponds to multiplying the amplitude X of the vibrator 52 by 1/α=(M1+M2)/M1. In this way, in this embodiment, the amplitude of the haptic presentation signal 3 is corrected by the vibration-data processing unit 39 on the basis of the decrease rate α of the acceleration.

As a result, the generated acceleration a2 of the game controller 10 and the attachment 20 become a2=kX/α/(M1+M2) =kX/M1. That is, the acceleration a2 generated according to the haptic presentation signal 3 whose amplitude has been corrected is equal to the generated acceleration a₀ before the mounting of the attachment 20.

For example, in the example described with reference to FIG. 11, the mass M2 of the attachment 20≈M1, and the decrease rate α of the acceleration=½. In such a case, the amplitude of the haptic output signal 4 is corrected to twice the haptic presentation signal 3, as shown in Part A of FIG. 12. By driving the voice coil motor 17 using this haptic output signal 4, substantially the same acceleration as that before the mounting of the attachment 20 can be generated. As a result, substantially the same vibration as that before the mounting of the attachment 20 is presented, and a predetermined haptic can be presented with high accuracy.

Note that there may a case where a maximum value or the like is set for the amplitude of the haptic presentation signal 3. For example, in a system where the maximum value of the amplitude is set to 1.0, in the case where the multiplication result of the inverse of the decrease rate α and the amplitude exceeds 1.0, the multiplication result is appropriately corrected to execute a process of setting the amplitude of the haptic output signal 4.

Alternatively, in order to avoid the harmful effect that the waveform collapses at the time when the amplitude becomes 1.0 and an abnormal sound is generated, the above-mentioned correction process may be performed by adding step-by-step calculation in accordance with the magnitude of the amplitude of the haptic presentation signal 3. That is, the correction amount is adjusted in accordance with the amplitude of the haptic presentation signal 3 so that the amplitude of the haptic output signal 4 falls within an appropriate range. For example, such a process is possible.

Further, another method of increasing the generated acceleration a of the composite controller 21 (the attachment 20 and the game controller 10) may be used in combination. In this case, by the vibration-data processing unit 39, the haptic presentation signal 3 is appropriately corrected in accordance with the respective methods of increasing the generated acceleration a, which will be described below.

For example, a passive radiator or the like for amplifying vibration may be provided in the attachment 20. The passive radiator is appropriately designed to have a resonant frequency near the resonant frequency of the vibration system including the attachment 20 and the game controller 10, for example. As a result, it is possible to increase the vibration amount with no power supply.

Further, another vibrating actuator (voice coil motor or the like) may be mounted in the attachment 20. This vibrating actuator can be fed and driven to increase the vibration amount. Note that the vibrating actuator in this attachment 20 may be driven by sharing the haptic output signal 4 transmitted from the game console body 30 to the game controller 10 via the extension terminal.

Further, a large VCM may be mounted on the attachment 20. In this case, the vibration system of the attachment 20 and the game controller 10 is driven by the large VCM in the attachment 20 to stop the driving of the VCM (the voice coil motor 17) in the game controller 10. As a result, the power consumption of the game controller 10 can be suppressed. In this way, the vibrating actuator and the large VCM mounted on the attachment 20 function as a vibrating device for exciting the game controller 10 (haptic presentation apparatus).

Further, the power may be supplied to the game controller 10 from a battery in the attachment 20 to suppress the power consumption of the game controller 10. Further, for example, assumption is made that a battery of 3.7 V is mounted on the game controller 10 and a battery of 5.0 V is mounted on the attachment 20. For example, by supplying a voltage of 5.0 V from the attachment 20 to the game controller 10, the maximum voltage to be applied to the voice coil motor 17 can be increased. As a result, even in the case where the amplitude of the haptic output signal 4 described above exceeds 1.0 (maximum value), the vibration amount can be compensated for by expanding the maximum value. As a result, it is possible to easily realize desired acceleration.

In Part B of FIG. 12, a graph showing an example of the haptic output signal 4 calculated by correcting the frequency component of the haptic presentation signal 3. Hereinafter, the process of correcting the frequency component of the haptic presentation signal 3 will be described.

In this embodiment, the vibration-data processing unit 39 calculates, on the basis of the mass data, the shift amount of the resonant frequency f₀ of the vibration system including the voice coil motor 17 along with the mounting of the attachment 20. As described above with reference to the formula (2), the resonant frequency f₀ of the vibration system is expressed by using the reduced mass M′.

The vibration-data processing unit 39 calculates, on the basis of the mass M2 (mass data) of the attachment 20, the reduced mass M′ in a vibration system on which the attachment 20 is mounted. Further, the calculated reduced mass M′ is used to calculate a resonant frequency f₀₁ in the vibration system on which the attachment 20 is mounted in accordance with the formula (2).

Further, the value of the resonant frequency f₀₀ before the mounting of the attachment 20 is read. Then, a shift amount Δf₀=f₀₀−f₀₁ of the resonant frequency f₀ along with the mounting of the attachment 20 is calculated. On the basis of this shift amount Δf₀ of the resonant frequency, the frequency component of the haptic presentation signal 3 is corrected. In this case, the shift amount Δf₀ of the resonant frequency is correction information regarding the frequency component of the haptic presentation signal 3. For example, a process such as pitch shifting corresponding to the shift amount Δf₀ is executed on the haptic presentation signal 3. Note that the pitch shifting is a process of shifting the frequency component by a predetermined frequency.

For example, assumption is made that the resonant frequency f₀₀ of the voice coil motor 17 is 53 Hz in a vibration system of the game controller 10 alone on which the attachment 20 has not been amounted. In this case, the maximum acceleration (pre-mounting acceleration a₀) can be output by setting the Sin wave of 53 Hz as the haptic presentation signal 3.

Further, assumption is made that the resonant frequency f₀₁ of the voice coil motor 17 changes to 50 Hz in the vibration system including the game controller 10 and the attachment 20 along with the mounting of the attachment 20. In this case, it is considered that the acceleration output for the haptic presentation signal 3 of the Sin waveform of 53 Hz becomes smaller than the original designed assumption.

Therefore, a process of pitch shifting to change the haptic presentation signal 3 from the Sin waveform of 53 Hz to the Sin waveform of 50 Hz is executed. That is, the haptic presentation signal 3 is corrected so that the frequency component of 53 Hz becomes the frequency component of 50 Hz. In Part B of FIG. 12, the period (1/f₀₀) of the haptic presentation signal 3 in which f₀₀=53 Hz and the period (1/f₀₁) of the haptic output signal 4 in which f₀₁=50 Hz are schematically illustrated using arrows.

As shown in Part B of FIG. 12, the entire waveform in the time-axis is expanded in the process of the pitch shifting. In this way, by correcting the haptic presentation signal 3, it is possible to output the largest acceleration as a vibration system even in the case where the attachment 20 is connected.

Note that also in the case where the haptic presentation signal 3 is not a simple Sin waveform and is a broadband signal including a wide frequency band, by adding a process of pitch shifting of 3 Hz to the haptic presentation signal 3 similarly, it is possible to avoid a decrease in the generated acceleration due to the change in the resonant frequency f₀. This makes it possible to realize vibration according to the design intention, and present a predetermined haptic perception with high accuracy.

In Part C of FIG. 12, a graph showing an example of the haptic output signal 4 calculated by correcting both the amplitude and the frequency component of the haptic presentation signal 3 is shown. In Part C of FIG. 12, the vibration-data processing unit 39 executes the correction of the amplitude described with reference to Part A of FIG. 12 and the correction of the frequency component described with reference to Part B of FIG. 12.

For example, a process of pitch shifting corrects the frequency component of the haptic presentation signal 3 so that the largest acceleration in the vibration system on which the attachment 20 has been mounted is output. Further, the amplitude of the pitch shifted haptic presentation signal 3 is corrected so that acceleration substantially the same as that before the mounting of the attachment 20 is generated. This makes it possible to generate desired acceleration efficiently. As a result, it is possible to present a sufficiently powerful haptic perception with high accuracy while suppressing the energy consumption.

As described above, in this embodiment, the voice coil motor 17 is controlled by the vibration-data processing unit 39 so that the vibration of the game controller 10 on which the attachment 20 has been mounted is substantially the same as that of the game controller 10 on which the attachment 20 has not been mounted. As a result, it is possible to generate substantially the same vibration before and after the mounting of the attachment 20. As a result, a decrease in the intensity of the haptic perception, or the like is avoided, and excellent haptic effects can be exhibited.

In addition, the method of correcting the haptic presentation signal 3, and the like are not limited. For example, the amplitude, the frequency component, and the like of the haptic presentation signal 3 may be appropriately corrected so as to reproduce a predetermined haptic perception used in the game content, in accordance with the mass M2 of the mounted attachment 20, or the like. Further, for example, the haptic presentation signal 3 may be corrected in accordance with a range in which the voice coil motor 17 is capable of appropriately vibrating.

For example, there is a possibility that a phenomenon (mechanical contact) in which the vibrator 52 of the voice coil motor 17 mechanically contacts the casing 13 or the like occurs due to a change in the weight of the vibration system when the attachment 20 is mounted. That is, there is a possibility that a mechanical interference between the voice coil motor 17 and the casing 13 occurs. The haptic presentation signal 3 may be corrected so that such a mechanical contact does not occur.

For example, an interference condition for avoiding the mechanical contact between the vibrator 52 and the casing 13 is set for the game controller 10. The interference condition is a condition that includes the limit values of the amplitude and the frequency of the haptic presentation signal 3 by which contact between the vibrator 52 and the casing 13 is avoided. That is, it can be said that the game controller 10 is designed so that the magnitude and the frequency specified by the interference condition have limit values that do not cause the mechanical contact.

For example, assumption is made that the resonant frequency f₀₀ of the game controller 10 alone is 53 Hz and the haptic presentation signal 3 of the Sin waveform of the frequency 50 Hz and the amplitude of 1.0 (maximum value) is set as the condition (interference condition) of the limit where the contact between the vibrator 52 and the casing 13 is avoided. That is, this interference condition means that there will be no mechanical contact even in the case where the amplitude is maximized at the frequency component 3 Hz lower than the resonant frequency f₀₀.

Assumption is made that the attachment 20 is mounted on this game controller 10 and the resonant frequency f₀₁ of the vibration system is 50 Hz. In such a case, the vibration-data processing unit 39 corrects the haptic presentation signal 3 having the Sin waveform of, for example, 50 Hz to the haptic output signal 4 having the Sin waveform of 47 Hz by the above-mentioned process of pitch shifting. That is, a process of correcting the frequency component similar to the resonant frequency f₀₁ after the mounting of the attachment 20 to a frequency component lower by 3 Hz is executed in accordance with the interference condition of the game controller 10 alone.

As described above, the vibration-data processing unit 39 corrects the haptic presentation signal 3 on the basis of the interference condition for the mechanical interference between the voice coil motor 17 and the casing 13. As a result, the problem of mechanical contact is avoided, and it is possible to avoid generation of abnormal sound due to a collision between the vibrator 52 and the casing 13, generation of unwanted vibration, and the like.

With reference to FIG. 10 again, the corrected haptic presentation signal 3 (the haptic output signal 4) is transmitted to the game controller 10 (Step 109). That is, in the case where it is determined in Step 107 that the attachment 20 has been mounted, the haptic output signal 4 is transmitted to the game controller 10 as a control signal for controlling the voice coil motor 17.

Note that in the case where it is determined that the attachment 20 has not been mounted because, for example, the attachment 20 is removed while the game content is in progress (No in Step 107), the correction process of the haptic presentation signal 3 is not executed. In this case, in Step 109, the haptic presentation signal 3 for vibrating the game controller 10 alone generated by the content processing unit 38 is transmitted as it is as a control signal for controlling the voice coil motor 17.

When the haptic presentation signal 3 is transmitted, the process of Step 103 and the subsequent Steps are executed again. Note that the mass M2 of the attachment 20 estimated in Step 105 is used to correct the haptic presentation signal 3 or the like also in the subsequent loop process as long as the attachment 20 is not removed, for example. As a result, it is possible to smoothly execute the loop process for correcting the haptic presentation signal 3.

As described above, in the control unit 33 according to this embodiment, the voice coil motor 17 exciting the game controller 10 is controlled. The control of the voice coil motor 17 is executed on the basis of the haptic presentation signal 3 for driving the voice coil motor 17 and the attachment information regarding the attachment 20 that is in contact with the game controller 10. This makes it possible to perform vibration control of the game controller 10 according to the attachment 20 and present a desired haptic perception.

In the case where an attachment for function extension or the like is mounted on an apparatus that presents a haptic perception, it is considered that the frequency-characteristics of the vibration system, or the like change. For example, in the case of connecting an attachment or the like having the shape of a gun to a grip-type rod-shaped controller, there is a possibility that the originally-intended vibration of the game designer does not occur.

In this embodiment, with respect to the attachment 20 to be mounted on the game controller 10, information regarding the presence or absence of mounting, the mass M2 of the attachment 20, and the like is acquired. Then, on the basis of the acquired information of the attachment 20, the haptic presentation signal of the voice coil motor 17 is corrected.

For example, the mass M2 of the attachment 20 is read on the basis of the device information of the attachment 20. As described above, by using a mechanism for detecting the connection state of the attachment 20, it is possible to accurately correct the haptic presentation signal 3 in accordance with the type of the attachment 20. As a result, it is possible to generate desired acceleration and present a desired haptic perception with high accuracy to the user 1.

Further, for example, the mass M2 of the attachment 20 is estimated on the basis of the generated acceleration a of the game controller 10. As a result, even in the case where the attachment 20 whose device information, mass, or the like is unknown, the attachment 20 having no communication function with the game controller 10, or the like is used, the haptic presentation signal 3 can be appropriately corrected. As a result, regardless of the type of the attachment 20, it is possible to appropriately present a desired haptic perception.

Further, in this embodiment, the amplitude and the frequency component of the haptic presentation signal 3 are corrected in accordance with the attachment information. As a result, it is possible to present a desired haptic perception with high accuracy regardless of the waveform of the haptic presentation signal 3, and the like.

The function of the Haptics presentation (haptic presentation) in the game controller 10 or the like is expected to become more generalized and sophisticated in the future. In this embodiment, the magnitude and the frequency component of the haptic presentation signal 3 can be corrected with high accuracy in accordance with the vibration model of the voice coil motor 17. As a result, even in the case where the attachment 20 or the like is mounted, it is possible to present a detailed haptic perception with sufficiently-high accuracy, and excellent haptic effects can be exhibited.

### Second Embodiment

The haptic presentation system according to a second embodiment of the present technology will be described. In the following description, description of the configurations and effects similar to those in the haptic presentation system 100 described in the above-mentioned embodiment will be omitted or simplified.

In this embodiment, the process of correcting the haptic presentation signal 3 is executed in accordance with the increase or decrease of the gripping force with which the user 1 grips the game controller 10. In the following, a case where the user 1 uses the game controller 10 alone will be described as an example. In this embodiment, the hand of the user 1 gripping the game controller 10 is an example of the contact body that is in contact with the haptic presentation apparatus.

When the force with which the user 1 grips the game controller 10 (gripping force) changes, the degree to which the game controller 10 is excited changes. For example, in the case where the user 1 grips the game controller 10 strongly, the game controller 10 is less likely to shake, and the acceleration a generated in the game controller 10 decreases.

The state in which the generated acceleration a has decreased by the increase of the gripping force can be regarded as a state in which the mass M of the vibration target 63 has substantially increased, for example, in the physical model shown in FIG. 6. That is, it can be said that the virtual mass of the game controller 10 alone changes with the change in the gripping force of the user 1. As factors for increasing or decreasing the gripping force, for example, factors such as a change in the situation due to the excited condition of the respective users and the like and a change in the user 1 are considered.

For example, in a region 5 surrounded by the dotted line of the lower graph of FIG. 9, the ratio of the acceleration a generated in the game controller 10 alone and the drive signal 2 (generated acceleration a/driving signal 2) changes in a state where the attachment 20 has not been mounted. Such a change is considered to be caused by a change in the gripping force with which the user 1 grips the game controller 10.

In this embodiment, the vibration-data processing unit 39 acquires gripping-force information relating to the gripping force of the user 1 gripping the game controller 10. Here, the gripping-force information is, for example, information capable of representing the gripping force of the user 1. Typically, data indicating a change in the gripping force, or the like is used as the gripping-force information. In this embodiment, the gripping-force information corresponds to the contact body information.

As described above, the ratio of the generated acceleration a and the drive signal 2, which is detected when the attachment 20 or the like has not been mounted, is data indicating a change in the gripping force. For example, the vibration-data processing unit 39 appropriately receives the acceleration data detected by the acceleration sensor 16 of the game controller 10, and calculates the ratio of the raw acceleration a and the drive signal 2 as data indicating a change in the grip force. In this way, in the vibration-data processing unit 39, the gripping-force information is calculated on the basis of the result of detecting the acceleration sensor 16 mounted on the game controller 10.

Note that the specific type and the like of the gripping-force information are not limited. For example, a configuration in which a pressure sensor or the like for detecting the gripping force is provided in the grip portion 11 (the casing 13) of the game controller 10 and the gripping force of the user 1 is directly detected may be employed. In addition, arbitrary data capable of representing the amount of change in the gripping force or the like may be used as appropriate.

When the gripping-force information (e.g., the ratio of the generated acceleration a and the driving signal 2) is acquired, the haptic presentation signal 3 is corrected on the basis of the gripping-force information, and the voice coil motor 17 is controlled on the basis of the corrected haptic presentation signal 3 (the haptic output signal 4). For example, in the case where the generated acceleration a has decreased, the vibration sensed by the user 1 has been weakened by the amount corresponding thereto. For this reason, in order to compensate for this, a process of increasing the amplitude of the haptic presentation signal 3, a process of shifting the frequency component of the haptic presentation signal 3, and the like (see FIG. 12, etc.) are executed.

The method of correcting the haptic presentation signal 3, and the like are not limited. For example, on the basis of to the ratio of the generated acceleration a and the drive signal 2, the increase in the virtual mass of the game controller 10 due to the increase in the gripping force of the user 1 is calculated. The increase of the virtual mass corresponds to the mass M2 of the attachment 20 in the first embodiment. For example, the amplitude and the frequency component of the haptic presentation signal 3 may be appropriately corrected on the basis of the increase. Further, a feedback process or the like for changing the amplitude and the frequency component of the haptic presentation signal 3 (drive signal 2) may be appropriately executed so that the ratio of the generated acceleration a and the drive signal 2 is maintained at a predetermined level.

In this way, in this embodiment, the voice coil motor 17 exciting the game controller 10 is controlled on the basis of the haptic presentation signal 3 and the gripping-force information regarding the gripping force of the user 1 gripping the game controller 10. Even in the case where the force or the like of the user 1 gripping the game controller 10 has changed, it is possible to appropriately vibrate the game controller 10, and exhibit excellent haptic effects.

Note that the process of correcting the drive signal 2 on the basis of the gripping-force information is not limited to the case where the game controller 10 is used alone, and can be applied to the case where the game controller 10 (the composite controller 21) on which the attachment 20 has been mounted is used. In this case, the composite controller 21 corresponds to the haptic presentation apparatus. For example, the amplitude and the frequency component of the haptic presentation signal 3 are appropriately corrected in accordance with the gripping force of the user 1 so that the acceleration a (post-mounting acceleration a₁) generated in the composite controller 21 is maintained at a predetermined level.

Further, both the process of correcting the haptic presentation signal 3 along with the mounting of the attachment 20 and the process of correcting the haptic presentation signal 3 along with the change in the gripping force of the user 1 may be executed. For example, the haptic presentation signal corrected on the basis of the mass M2 of the attachment 20, or the like is corrected on the basis of the change in the gripping force of the user 1 (increase or decrease in the virtual mass). Such a process may be executed.

### Other Embodiments

The present technology is not limited to the above-mentioned embodiments and various other embodiments can be realized.

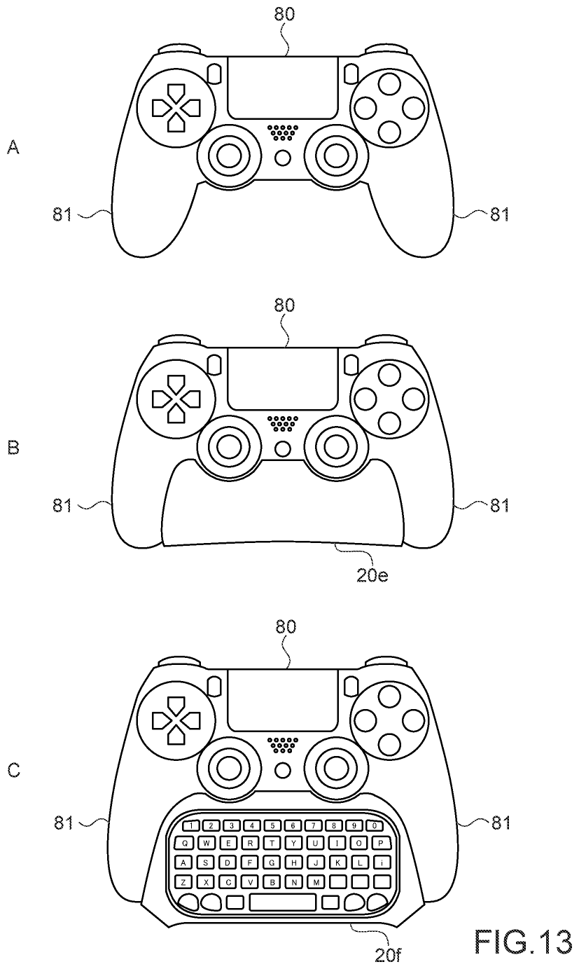

FIG. 13 to FIG. 15 are each a schematic diagram showing an example of the haptic presentation apparatus and the attachment. FIG. 13 is a schematic diagram showing the external appearance of a two-handed game controller 80 and the attachment 20 therefor. In Part A of FIG. 13, the two-handed game controller 80 on which a vibrating actuator (voice coil motor or the like) has been mounted is illustrated. This two-handed game controller 80 functions as the haptic presentation apparatus.

The game controller 80 includes right and left grip portions 81, and for example, a vibrating actuator is mounted inside each of the grip portions 81. The user 1 grips the right and left grip portions 81 with the right and left hands and operates selection buttons, analogue sticks, and the like to perform an input operation for progressing the game content. Further, the vibrating actuators vibrate as appropriate to present a predetermined haptic perception to the right and left hands of the user 1.

An attachment 20e shown in Part B of FIG. 13 is an external battery, which extends the operation time of the two-handed game controller 80. Further, an attachment 20f shown in Part C of FIG. 13 is an external keyboard for inputting characters, and supports character inputting of the user 1, and the like. The attachments 20e and 20f are mounted between the right and left grip portions 81.

For example, in the case where the attachments 20e and 20f are configured to be capable of communicating with the two-handed game controller 80, the device information of each of the attachments 20 is acquired, and the mass of each of the attachments 20 is read from a database or the like. Alternatively, in the case where an acceleration sensor or the like is mounted on the game controller 80, a process of estimating the mass of each of the attachments 20 or the like may be executed. Then, the haptic presentation signal 3 in the case where the two-handed game controller 80 is used alone is corrected on the basis of the mass of the attachment 20.

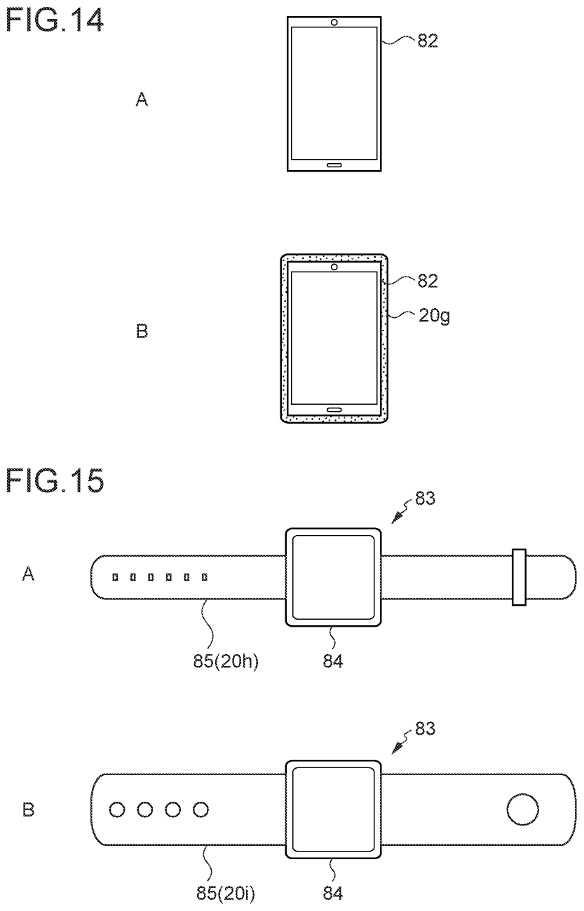

FIG. 14 is a schematic diagram showing the external appearance of a mobile terminal 82 and the attachment 20 therefor. In Part A of FIG. 14, the mobile terminal 82 equipped with a vibrating actuator and an acceleration sensor is illustrated. The mobile terminal 82 is, for example, a smart phone, a tablet, or the like, and is a terminal device that can be used by the user 1 with one hand or both hands. In addition, the type and the like of the mobile terminal 82 are not limited. This mobile terminal 82 functions as the haptic presentation apparatus.

An attachment 20g shown in Part B of FIG. 14 is a cover of the mobile terminal 82. The attachment 20g is mounted on the mobile terminal 82 so that, for example, display of the mobile terminal 82 can be seen, and has a function of protecting the mobile terminal 82, and the like. The shape and the like of the cover (the attachment 20g) are not limited. The mobile terminal 82 estimates the mass of the attachment 20g by, for example, vibrating with a predetermined test waveform. Alternatively, the mass of the attachment 20g, and the like may be set by the user 1. The haptic presentation signal 3 for presenting a predetermined haptic perception is corrected on the basis of the mass of the attachment 20g, and the like.

FIG. 15 is a schematic diagram showing the external appearance of a wearable device 83 and the attachment 20 therefor. The smartwatch-type wearable device 83 is shown in Part A of FIG. 15. The wearable device 83 is used by, for example, being worn on the arm of the user 1. In addition, the type and the like of the wearable device 83 are not limited, and an arbitrary device configured to be wearable on each part of the body of the user 1 may be used.

The wearable device 83 includes a main body 84 on which a vibrating actuator and an acceleration sensor are mounted, and a mounting band 85 for mounting the main body 84 on the body (arm or the like) of the user 1. In the example shown in FIG. 15, the main body 84 functions as the haptic presentation apparatus. Further, the mounting band 85 is an attachment 20h configured to be attachable/detachable to the main body 84.

Part B of FIG. 14 shows the wearable device 83 on which a band (an attachment 20i) different from the mounting band 85 shown in Part A of FIG. 14 is mounted. Thus, even in the case where the mounting band 85 (the attachment 20h, 20i, or the like) is replaced, it is possible to present a predetermined haptic perception by appropriately correcting the haptic presentation signal 3 for vibrating the main body 84 (vibrating actuator) in accordance with the mass of the mounting band 85, or the like.

As described above, the haptic presentation signal 3 for driving the vibrating actuator can be appropriately corrected by using the present technology regardless of the types of the haptic presentation apparatus and the attachment 20. As a result, it is possible to present a predetermined haptic perception intended by the designer or the like with high accuracy. Note that the present technology is not limited to the above-mentioned example, and is applicable to the case where an arbitrary haptic presentation apparatus or the attachment 20 is used.

In the above description, as attachment information, information regarding the mass of the attachment 20 has been acquired. The present technology is not limited thereto. For example, information regarding the shape, material, stiffness, or the like of the attachment 20 may be acquired, and a process of correcting the haptic presentation signal 3, or the like may be executed on the basis of the information.

For example, in the case where the distance between the portion gripped by the user 1 and the vibrating actuator (VCM or the like) is apart, a process of correcting the amplitude of the haptic presentation signal 3 to be large may be executed. Further, for example, in the case where the material of the attachment 20 is soft, a process of correcting the amplitude of the haptic presentation signal 3 to be large may be executed. As a result, it is possible to appropriately present a predetermined haptic perception even in the case where vibration is hard to be transmitted.

In the above description, the process of correcting the haptic presentation signal 3 has been executed on the basis of the mass of the attachment 20, or the like. For example, in the case where the attachment 20 has been mounted, a process of increasing the amplitude of the haptic presentation signal 3 at a predetermined ratio (default value) may be executed regardless of the type of the attachment 20, or the like. As a result, it is possible to reduce the computation cost necessary for the process of correcting the haptic presentation signal 3. For example, such a process may be executed.

In the above, the case where a linear vibrating actuator such as a voice coil motor is used has been described. Another vibrating actuator (vibrating device) may be used in place of the linear vibrating actuator. For example, the present technology is applicable to the case where a rotation-type vibrating device such as an eccentric motor is used as a vibrating actuator. In this case, by appropriately adjusting the rotational velocity and the rotational pattern or the like of the eccentric motor, it is possible to suppress a decrease in the generated acceleration. In addition, the present technology is applicable to a haptic presentation apparatus using an arbitrary vibrating actuator.

At least two features of the above-mentioned features according to the present technology may be combined. Specifically, various features described in each embodiment may be arbitrarily combined without distinguishing the embodiments with each other. Further, the various effects described above are merely examples and are not limited, and additional effects may be exerted.

Note that the present technology may also take the following configurations.
(1) An information processing apparatus, including:
   a haptic control unit that controls, on a basis of a haptic presentation signal according to haptic content to be presented to a haptic presentation apparatus and contact body information relating to a contact body that is in contact with the haptic presentation apparatus, a haptic output signal to be output to the haptic presentation apparatus.
(2) The information processing apparatus according to (1), in which
   the haptic control unit controls the haptic output signal on a basis of correction information and the haptic presentation signal, the correction information being used for correcting the haptic presentation signal on a basis of the contact body information.
(3) The information processing apparatus according to (2), in which
   the haptic presentation signal is a signal that represents an amplitude and a frequency component of a vibrating device for exciting the haptic presentation apparatus, and
   the haptic control unit generates, on a basis of the contact body information, the correction information regarding at least one of the amplitude and the frequency component represented by the haptic presentation signal.
(4) The information processing apparatus according to (3), in which
   the contact body includes an attachment to be mounted on the haptic presentation apparatus, and
   the haptic control unit acquires, as the contact body information, mass information regarding mass of the attachment.
(5) The information processing apparatus according to (4), in which
   the haptic control unit calculates, on a basis of the mass information, a rate of change in acceleration along with mounting of the attachment, the acceleration being generated in the haptic presentation apparatus due to vibration of the vibrating device.
(6) The information processing apparatus according to (5), in which
   the haptic control unit corrects the amplitude of the haptic presentation signal on a basis of the rate of change in the acceleration.
(7) The information processing apparatus according to any one of (4) to (6), in which
   the haptic control unit calculates, on a basis of the mass information, a shift amount of a resonant frequency of a vibration system including the vibrating device along with mounting of the attachment.
(8) The information processing apparatus according to (7), in which
   the haptic control unit corrects, on a basis of the shift amount of the resonant frequency, the frequency component of the haptic presentation signal.
(9) The information processing apparatus according to any one of (4) to (8), in which
   the attachment is capable of supplying device information of the attachment, and
   the haptic control unit acquires the mass information on a basis of the device information of the attachment. (10) The information processing apparatus according to any one of (4) to (9), in which
   the haptic control unit acquires the mass information on a basis of input information input by a user. (11) The information processing apparatus according to any one of (4) to (10), in which
   the haptic presentation apparatus includes an acceleration sensor for detecting acceleration of the haptic presentation apparatus, and
   the haptic control unit calculates the mass information on a basis of a detection result of the acceleration sensor. (12) The information processing apparatus according to (11), in which
   the acceleration sensor detects first acceleration generated, in accordance with a predetermined vibration signal, in the haptic presentation apparatus on which the attachment has been mounted, and
   the haptic control unit acquires second acceleration generated, in accordance with the predetermined vibration signal, in the haptic presentation apparatus on which the attachment has not been mounted, and calculates the mass information on a basis of the first acceleration and the second acceleration.
(13) The information processing apparatus according to (11) or (12), in which
   the haptic control unit calculates the mass information on a basis of a temporal change in the acceleration detected by the acceleration sensor.
(14) The information processing apparatus according to any one of (3) to (13), in which
   the vibrating device is supported by a casing of the haptic presentation apparatus, and
   the haptic control unit corrects the haptic presentation signal on a basis of an interference condition regarding a mechanical interference between the vibrating device and the casing.
(15) The information processing apparatus according to any one of (3) to (14), in which
   the vibrating device is a linear vibrating actuator. (16) The information processing apparatus according to (15), in which
   the linear vibrating actuator is a voice coil motor.
(17) The information processing apparatus according to any one of (1) to (16), in which
   the contact body includes a hand of a user gripping the haptic presentation apparatus, and
   the haptic control unit acquires, as the contact body information, gripping-force information regarding a gripping force of the user gripping the haptic presentation apparatus.
(18) The information processing apparatus according to (17), in which
   the haptic presentation apparatus includes an acceleration sensor for detecting acceleration of the haptic presentation apparatus, and
   the haptic control unit calculates the gripping-force information on a basis of a detection result of the acceleration sensor.
(19) An information processing method executed by a computer system, including:
   controlling, on a basis of a haptic presentation signal according to haptic content to be presented to a haptic presentation apparatus and contact body information relating to a contact body that is in contact with the haptic presentation apparatus, a haptic output signal to be output to the haptic presentation apparatus.
(20) A program that causes a computer system to execute the following step of:
   controlling, on a basis of a haptic presentation signal according to haptic content to be presented to a haptic presentation apparatus and contact body information relating to a contact body that is in contact with the haptic presentation apparatus, a haptic output signal to be output to the haptic presentation apparatus.

### REFERENCE SIGNS LIST

1 user
3 haptic presentation signal
4 haptic output signal
10, 80 game controller
13 casing
16 acceleration sensor
17 voice coil motor
20, 20a to 20i attachment
21 composite controller
30 game console body
36 control program
37 mass database
38 content processing unit
39 vibration-data processing unit
63 vibration target
100 haptic presentation system

1. An information processing apparatus comprising:
a haptic control unit that controls, on a basis of a haptic presentation signal according to haptic content to be presented to a haptic presentation apparatus and contact body information relating to a contact body that is in contact with the haptic presentation apparatus, a haptic output signal to be output to the haptic presentation apparatus.

2. The information processing apparatus according to claim 1, wherein
the haptic control unit controls the haptic output signal on a basis of correction information and the haptic presentation signal, the correction information being used for correcting the haptic presentation signal on a basis of the contact body information.

3. The information processing apparatus according to claim 2, wherein
the haptic presentation signal is a signal that represents an amplitude and a frequency component of a vibrating device for exciting the haptic presentation apparatus, and
the haptic control unit generates, on a basis of the contact body information, the correction information regarding at least one of the amplitude and the frequency component represented by the haptic presentation signal.

4. The information processing apparatus according to claim 3, wherein
the contact body includes an attachment to be mounted on the haptic presentation apparatus, and
the haptic control unit acquires, as the contact body information, mass information regarding mass of the attachment.

5. The information processing apparatus according to claim 4, wherein
the haptic control unit calculates, on a basis of the mass information, a rate of change in acceleration along with mounting of the attachment, the acceleration being generated in the haptic presentation apparatus due to vibration of the vibrating device.

6. The information processing apparatus according to claim 5, wherein
the haptic control unit corrects the amplitude of the haptic presentation signal on a basis of the rate of change in the acceleration.

7. The information processing apparatus according to claim 4, wherein
the haptic control unit calculates, on a basis of the mass information, a shift amount of a resonant frequency of a vibration system including the vibrating device along with mounting of the attachment.

8. The information processing apparatus according to claim 7, wherein
the haptic control unit corrects, on a basis of the shift amount of the resonant frequency, the frequency component of the haptic presentation signal.

9. The information processing apparatus according to claim 4, wherein
the attachment is capable of supplying device information of the attachment, and
the haptic control unit acquires the mass information on a basis of the device information of the attachment.

10. The information processing apparatus according to claim 4, wherein
the haptic control unit acquires the mass information on a basis of input information input by a user.

11. The information processing apparatus according to claim 4, wherein
the haptic presentation apparatus includes an acceleration sensor for detecting acceleration of the haptic presentation apparatus, and
the haptic control unit calculates the mass information on a basis of a detection result of the acceleration sensor.

12. The information processing apparatus according to claim 11, wherein
the acceleration sensor detects first acceleration generated, in accordance with a predetermined vibration signal, in the haptic presentation apparatus on which the attachment has been mounted, and
the haptic control unit acquires second acceleration generated, in accordance with the predetermined vibration signal, in the haptic presentation apparatus on which the attachment has not been mounted, and calculates the mass information on a basis of the first acceleration and the second acceleration.

13. The information processing apparatus according to claim 11, wherein
the haptic control unit calculates the mass information on a basis of a temporal change in the acceleration detected by the acceleration sensor.

14. The information processing apparatus according to claim 3, wherein
the vibrating device is supported by a casing of the haptic presentation apparatus, and
the haptic control unit corrects the haptic presentation signal on a basis of an interference condition regarding a mechanical interference between the vibrating device and the casing.

15. The information processing apparatus according to claim 3, wherein
the vibrating device is a linear vibrating actuator.

16. The information processing apparatus according to claim 15, wherein
the linear vibrating actuator is a voice coil motor.

17. The information processing apparatus according to claim 1, wherein
the contact body includes a hand of a user gripping the haptic presentation apparatus, and
the haptic control unit acquires, as the contact body information, gripping-force information regarding a gripping force of the user gripping the haptic presentation apparatus.

18. The information processing apparatus according to claim 17, wherein
the haptic presentation apparatus includes an acceleration sensor for detecting acceleration of the haptic presentation apparatus, and
the haptic control unit calculates the gripping-force information on a basis of a detection result of the acceleration sensor.

19. An information processing method executed by a computer system, comprising:
controlling, on a basis of a haptic presentation signal according to haptic content to be presented to a haptic presentation apparatus and contact body information relating to a contact body that is in contact with the haptic presentation apparatus, a haptic output signal to be output 20 to the haptic presentation apparatus.

20. A program that causes a computer system to execute the following step of:
controlling, on a basis of a haptic presentation signal according to haptic content to be presented to a haptic presentation apparatus and contact body information relating to a contact body that is in contact with the haptic presentation apparatus, a haptic output signal to be output to the haptic presentation apparatus.
